(19) United States
(12) Patent Application Publication
(10) Pub. No.: US 2025/0016840 A1
(43) Pub. Date: Jan. 9, 2025

(54) METHODS AND APPARATUSES FOR INITIAL ACCESS

(71) Applicant: QUALCOMM INCORPORATED, San Diego, CA (US)

(72) Inventors: Saeid Sahraei, San Diego, CA (US); Yu Zhang, San Diego, CA (US); Hung Dinh Ly, San Diego, CA (US); Peter Gaal, San Diego, CA (US); Krishna Kiran Mukkavilli, San Diego, CA (US)

(21) Appl. No.: 18/707,048

(22) PCT Filed: Jan. 20, 2022
(86) PCT No.: PCT/CN2022/072936

§ 371 Date: May 2, 2024

(51) Int. Cl. H04W 74/0833; H04B 7/06; H04W 72/0453

(52) U.S. Cl. CPC H04W 74/0833; H04B 7/06952; H04W 72/0453

(57) ABSTRACT

Methods, systems, and devices for wireless communications are described. In some systems, a user equipment (UE) and a base station may participate in a one-shot initial access procedure involving a reconfigurable intelligent surface (RIS) divided into a number of sub-RISs, each sub-RIS associated with a different configuration for reflecting signaling from the base station. In some aspects, the base station may configure each sub-RIS to have a different frequency shift and transmit, to the UE, a parameter indicating a quantity of synchronization rasters associated with each of a set of beams that the base station may use as part of the one-shot initial access procedure. The UE may, for each beam, monitor a quantity of monitoring occasions corresponding to the quantity of synchronization rasters and transmit random access signaling to the base station based on which synchronization raster of which beam provides a greatest signal strength at the UE.

### CROSS REFERENCE

The present application is a 371 national stage filing of International PCT Application No. PCT/CN2022/072936 by Sahraei et al. entitled “METHODS AND APPARATUSES FOR INITIAL ACCESS,” filed Jan. 20, 2022, which is assigned to the assignee hereof, and which is expressly incorporated by reference in its entirety herein.

### FIELD OF TECHNOLOGY

The following relates to wireless communications, including methods and apparatuses for initial access.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some systems, two or more devices may communicate with each other via a reflective surface. For example, a first device may transmit signaling toward the reflective surface and a second device may receive the signaling reflected off the reflective surface.

### SUMMARY

The described techniques relate to improved methods, systems, devices, and apparatuses that support one-shot initial access. As described herein, a one-shot initial access procedure may refer to a transmission of a single set of reference signals via multiple directional beams from a base station toward a user equipment (UE) and an expectation for the UE to respond with an indication of a suitable directional beam for communication between the base station and the UE based on the transmission of the single set of reference signals, the multiple directional beams, and one or more receive beams used by the UE. Generally, the described techniques provide for a connection establishment between a UE and a base station via a one-shot initial access procedure involving a reflective surface, such as a reconfigurable intelligent surface (RIS). To support a one-shot initial access procedure involving an RIS, a base station may configure the RIS into a number of portions (which may be referred to herein as sub-RISs or sub-segments) and each portion of the RIS may reflect signaling from the base station in a different direction with a different frequency shift (e.g., a different doppler shift).

In some implementations, and to support a mechanism according to which the base station or the UE obtains knowledge of which portion of the RIS reflects signaling toward the UE, the base station may configure the UE to monitor a quantity of monitoring occasions for each of a set of beams based on a quantity of reflected beams from the RIS. For example, the base station may indicate a quantity of synchronization rasters for each beam and the UE may, for each beam, monitor a quantity of monitoring occasions based on the quantity of synchronization rasters. The UE may convey which synchronization raster of which beam provides a suitable signal strength via random access signaling to the base station, such as via a selection of one or both of a random access preamble and a random access occasion.

In some other implementations, and similarly to support a mechanism according to which the base station or the UE obtains knowledge of which portion of the RIS reflects signaling toward a UE, the base station may maintain the division of the RIS into the number of portions at least until after a UE transmits a random access preamble to the base station. As such, the base station may monitor a quantity of different random access occasions for the random access preamble. The quantity of random access occasions may be based on the quantity of reflected beams, and respective frequency shifts associated with each of the reflected beams, from the RIS. As such, the base station may infer which portion of the RIS reflects signaling between the UE and the base station based on during which random access occasion the base station receives the random access preamble from the UE.

A method for wireless communication at a UE is described. The method may include receiving, from a base station, a control message indicating a quantity of synchronization rasters for each beam of a set of multiple beams, measuring, for each beam of the set of multiple beams, one or more synchronization signal blocks (SSBs) over a quantity of monitoring occasions based on the quantity of synchronization rasters for each beam, and transmitting, to the base station, a random access preamble during a random access occasion selected based on the measuring.

An apparatus for wireless communication at a UE is described. The apparatus may include a processor, memory coupled with the processor, and instructions stored in the memory. The instructions may be executable by the processor to cause the apparatus to receive, from a base station, a control message indicating a quantity of synchronization rasters for each beam of a set of multiple beams, measure, for each beam of the set of multiple beams, one or more SSBs over a quantity of monitoring occasions based on the quantity of synchronization rasters for each beam, and transmit, to the base station, a random access preamble during a random access occasion selected based on the measuring.

Another apparatus for wireless communication at a UE is described. The apparatus may include means for receiving, from a base station, a control message indicating a quantity of synchronization rasters for each beam of a set of multiple beams, means for measuring, for each beam of the set of multiple beams, one or more SSBs over a quantity of monitoring occasions based on the quantity of synchronization rasters for each beam, and means for transmitting, to the base station, a random access preamble during a random access occasion selected based on the measuring.

A non-transitory computer-readable medium storing code for wireless communication at a UE is described. The code may include instructions executable by a processor to receive, from a base station, a control message indicating a quantity of synchronization rasters for each beam of a set of multiple beams, measure, for each beam of the set of multiple beams, one or more SSBs over a quantity of monitoring occasions based on the quantity of synchronization rasters for each beam, and transmit, to the base station, a random access preamble during a random access occasion selected based on the measuring.

In some examples of the method, apparatuses, and non-transitory computer-readable medium described herein, measuring, for each beam of the set of multiple beams, the one or more SSBs over the quantity of monitoring occasions may include operations, features, means, or instructions for determining that a SSB associated with a synchronization raster of a beam of the set of multiple beams may have a signal strength that satisfies a threshold signal strength, where transmitting the random access preamble during the random access occasion may be based on the beam and the synchronization raster.

In some examples of the method, apparatuses, and non-transitory computer-readable medium described herein, where different synchronization rasters correspond to different random access occasions and the method, apparatuses, and non-transitory computer-readable medium may include further operations, features, means, or instructions for calculating a frequency location associated with the random access occasion based on the beam and the synchronization raster and selecting the random access occasion based on the frequency location.

Some examples of the method, apparatuses, and non-transitory computer-readable medium described herein may further include operations, features, means, or instructions for receiving an indication of a parameter associated with a separation in a frequency domain between the different random access occasions, where calculating the frequency location associated with the random access occasion may be further based on the parameter.

In some examples of the method, apparatuses, and non-transitory computer-readable medium described herein, where multiple synchronization rasters of the beam correspond to the random access occasion and the method, apparatuses, and non-transitory computer-readable medium may include further operations, features, means, or instructions for receiving, from the base station, an indication of a set of random access preambles that may be allocated to the multiple synchronization rasters, each synchronization raster of the multiple synchronization rasters being allocated a different subset of random access preambles of the set of random access preambles and selecting the random access preamble from a subset of random access preambles that may be allocated to the synchronization raster, where transmitting the random access preamble during the random access occasion may be based on the selecting of the random access preamble.

In some examples of the method, apparatuses, and non-transitory computer-readable medium described herein, where multiple synchronization rasters of the beam correspond to the random access occasion and the method, apparatuses, and non-transitory computer-readable medium may include further operations, features, means, or instructions for receiving, from the base station, a random access response associated with the random access preamble and transmitting, to the base station and based on receiving the random access response, a random access message indicating the synchronization raster.

Some examples of the method, apparatuses, and non-transitory computer-readable medium described herein may further include operations, features, means, or instructions for generating a sequence for a demodulation reference signal of the random access message based on the synchronization raster, where transmitting the random access message indicating the synchronization raster includes and transmitting, via the random access message, the demodulation reference signal using the sequence that may be generated based on the synchronization raster.

In some examples of the method, apparatuses, and non-transitory computer-readable medium described herein, transmitting the random access message indicating the synchronization raster may include operations, features, means, or instructions for transmitting an indication of the synchronization raster via a field of the random access message.

Some examples of the method, apparatuses, and non-transitory computer-readable medium described herein may further include operations, features, means, or instructions for mapping the beam and the synchronization raster to an index, calculating a frequency location associated with the random access occasion based on the index, and selecting the random access occasion based on the frequency location.

In some examples of the method, apparatuses, and non-transitory computer-readable medium described herein, different beam and synchronization raster pairs correspond to different indices in accordance with a mapping function.

Some examples of the method, apparatuses, and non-transitory computer-readable medium described herein may further include operations, features, means, or instructions for receiving, from the base station, an indication of a procedure according to which the UE selects one or both of the random access preamble and the random access occasion based on the quantity of synchronization rasters being associated with each beam of the set of multiple beams.

In some examples of the method, apparatuses, and non-transitory computer-readable medium described herein, the procedure may be associated with different synchronization rasters corresponding to different random access occasions, or multiple synchronization rasters of a same beam corresponding to a same random access occasion, or use of an index mapped to a beam and a synchronization raster to calculate a frequency location associated with the random access occasion, or a configuration of a surface for reflecting SSBs from the base station to the UE and for reflecting the random access preamble from the UE to the base station.

In some examples of the method, apparatuses, and non-transitory computer-readable medium described herein, the quantity of synchronization rasters may be equal to a summation of a quantity of reflected beams from a surface and one synchronization raster associated with direct signaling from the base station without reflection from the surface, and one or both of the random access preamble and the random access occasion may be associated with a reflected beam of the quantity of reflected beams.

In some examples of the method, apparatuses, and non-transitory computer-readable medium described herein, each beam and synchronization raster pair corresponds to a different monitoring occasion of a beam sweeping procedure between the base station and the UE and the quantity of monitoring occasions for each beam may be equal to the quantity of synchronization rasters for each beam.

A method for wireless communication at a base station is described. The method may include transmitting, to a UE, a control message indicating a quantity of synchronization rasters for each beam of a set of multiple beams, transmitting, for each beam of the set of multiple beams, one or more SSBs, monitoring a set of multiple random access occasions based on the quantity of synchronization rasters for each beam of the set of multiple beams, and receiving, from the UE, a random access preamble during a random access occasion based on the monitoring.

An apparatus for wireless communication at a base station is described. The apparatus may include a processor, memory coupled with the processor, and instructions stored in the memory. The instructions may be executable by the processor to cause the apparatus to transmit, to a UE, a control message indicating a quantity of synchronization rasters for each beam of a set of multiple beams, transmit, for each beam of the set of multiple beams, one or more SSBs, monitor a set of multiple random access occasions based on the quantity of synchronization rasters for each beam of the set of multiple beams, and receive, from the UE, a random access preamble during a random access occasion based on the monitoring.

Another apparatus for wireless communication at a base station is described. The apparatus may include means for transmitting, to a UE, a control message indicating a quantity of synchronization rasters for each beam of a set of multiple beams, means for transmitting, for each beam of the set of multiple beams, one or more SSBs, means for monitoring a set of multiple random access occasions based on the quantity of synchronization rasters for each beam of the set of multiple beams, and means for receiving, from the UE, a random access preamble during a random access occasion based on the monitoring.

A non-transitory computer-readable medium storing code for wireless communication at a base station is described. The code may include instructions executable by a processor to transmit, to a UE, a control message indicating a quantity of synchronization rasters for each beam of a set of multiple beams, transmit, for each beam of the set of multiple beams, one or more SSBs, monitor a set of multiple random access occasions based on the quantity of synchronization rasters for each beam of the set of multiple beams, and receive, from the UE, a random access preamble during a random access occasion based on the monitoring.

In some examples of the method, apparatuses, and non-transitory computer-readable medium described herein, the random access preamble and the random access occasion may be associated with a synchronization raster of a beam of the set of multiple beams associated with a signal strength that satisfies a threshold signal strength.

In some examples of the method, apparatuses, and non-transitory computer-readable medium described herein, where different synchronization rasters correspond to different random access occasions and the method, apparatuses, and non-transitory computer-readable medium may include further operations, features, means, or instructions for transmitting, to the UE, an indication of a parameter associated with a separation in a frequency domain between the different random access occasions, the parameter being used for a calculation, at the UE, of a frequency location associated with the random access occasion, where receiving the random access preamble during the random access occasion may be based on the beam, the synchronization raster, and the parameter.

In some examples of the method, apparatuses, and non-transitory computer-readable medium described herein, where multiple synchronization rasters of the beam correspond to the random access occasion and the method, apparatuses, and non-transitory computer-readable medium may include further operations, features, means, or instructions for transmitting, to the UE, an indication of a set of random access preambles that may be allocated to the multiple synchronization rasters, each synchronization raster of the multiple synchronization rasters being allocated a different subset of random access preambles of the set of random access preambles, where receiving the random access preamble may be based on the transmitting of the indication of the set of random access preambles that may be allocated to the multiple synchronization rasters.

In some examples of the method, apparatuses, and non-transitory computer-readable medium described herein, where multiple synchronization rasters of the beam correspond to the random access occasion and the method, apparatuses, and non-transitory computer-readable medium may include further operations, features, means, or instructions for transmitting, to the UE, a random access response associated with the random access preamble and receiving, from the UE and based on transmitting the random access response, a random access message indicating the synchronization raster.

In some examples of the method, apparatuses, and non-transitory computer-readable medium described herein, receiving the random access message indicating the synchronization raster may include operations, features, means, or instructions for receiving, via the random access message, a demodulation reference signal associated with a sequence that may be based on the synchronization raster.

In some examples of the method, apparatuses, and non-transitory computer-readable medium described herein, receiving the random access message indicating the synchronization raster may include operations, features, means, or instructions for receiving an indication of the synchronization raster via a field of the random access message.

Some examples of the method, apparatuses, and non-transitory computer-readable medium described herein may further include operations, features, means, or instructions for transmitting, to the UE, an indication of a procedure according to which the UE selects one or both of the random access preamble and the random access occasion based on the quantity of synchronization rasters being associated with each beam of the set of multiple beams.

Some examples of the method, apparatuses, and non-transitory computer-readable medium described herein may further include operations, features, means, or instructions for transmitting, to a device controlling a surface, an indication of a configuration of the surface for reflecting communications between the base station and the UE based on one or both of the random access preamble and the random access occasion.

In some examples of the method, apparatuses, and non-transitory computer-readable medium described herein, the quantity of synchronization rasters may be equal to a summation of a quantity of reflected beams from a surface and one synchronization raster associated with direct signaling from the base station without reflection from the surface, and one or both of the random access preamble and the random access occasion may be associated with a reflected beam of the quantity of reflected beams.

In some examples of the method, apparatuses, and non-transitory computer-readable medium described herein, each beam and synchronization raster pair corresponds to a different monitoring occasion of a beam sweeping procedure between the base station and the UE and the quantity of monitoring occasions for each beam may be equal to the quantity of synchronization rasters for each beam.

A method for wireless communication at a device controlling a surface is described. The method may include receiving, from a base station, an indication to divide the surface into a set of portions of the surface, each portion of the set of portions associated with a different reflected beam and a different frequency shift, configuring the set of portions of the surface in accordance with the indication, for reflecting of SSBs from the base station to a UE and for reflecting of a random access preamble from the UE to the base station, the set of portions of the surface in accordance with the indication, and receiving, from the base station, a reconfiguration for the surface for reflecting communications between the base station and the UE based on the configuring of the set of portions of the surface.

An apparatus for wireless communication at a device controlling a surface is described. The apparatus may include a processor, memory coupled with the processor, and instructions stored in the memory. The instructions may be executable by the processor to cause the apparatus to receive, from a base station, an indication to divide the surface into a set of portions of the surface, each portion of the set of portions associated with a different reflected beam and a different frequency shift, configure the set of portions of the surface in accordance with the indication, for reflecting of SSBs from the base station to a UE and for reflecting of a random access preamble from the UE to the base station, the set of portions of the surface in accordance with the indication, and receive, from the base station, a reconfiguration for the surface for reflecting communications between the base station and the UE based on the configuring of the set of portions of the surface.

Another apparatus for wireless communication at a device controlling a surface is described. The apparatus may include means for receiving, from a base station, an indication to divide the surface into a set of portions of the surface, each portion of the set of portions associated with a different reflected beam and a different frequency shift, means for configuring the set of portions of the surface in accordance with the indication, for reflecting of SSBs from the base station to a UE and for reflecting of a random access preamble from the UE to the base station, the set of portions of the surface in accordance with the indication, and means for receiving, from the base station, a reconfiguration for the surface for reflecting communications between the base station and the UE based on the configuring of the set of portions of the surface.

A non-transitory computer-readable medium storing code for wireless communication at a device controlling a surface is described. The code may include instructions executable by a processor to receive, from a base station, an indication to divide the surface into a set of portions of the surface, each portion of the set of portions associated with a different reflected beam and a different frequency shift, configure the set of portions of the surface in accordance with the indication, for reflecting of SSBs from the base station to a UE and for reflecting of a random access preamble from the UE to the base station, the set of portions of the surface in accordance with the indication, and receive, from the base station, a reconfiguration for the surface for reflecting communications between the base station and the UE based on the configuring of the set of portions of the surface.

In some examples of the method, apparatuses, and non-transitory computer-readable medium described herein, reconfiguring, for the reflecting of the communications between the base station and the UE, the surface in accordance with the reconfiguration.

In some examples of the method, apparatuses, and non-transitory computer-readable medium described herein, the reconfiguration for the surface may be based on a frequency shift of a portion of the surface, the portion of the surface associated with a successful reflection of the random access preamble from the UE to the base station.

In some examples of the method, apparatuses, and non-transitory computer-readable medium described herein, the surface may be an RIS including a set of reflective elements.

A method for wireless communication at a base station is described. The method may include transmitting, to a device controlling a surface, an indication to divide the surface into a set of portions of the surface, each portion of the set of portions associated with a different reflected beam and a different frequency shift, transmitting, to a UE via the surface, one or more SSBs for each beam of a set of multiple beams, receiving, from the UE, a random access preamble during a random access occasion based on the transmitting of the one or more SSBs for each beam of the set of multiple beams, and transmitting, to the device controlling the surface, an indication of a reconfiguration for the surface for reflecting communications between the base station and the UE based on the receiving of the random access preamble during the random access occasion.

An apparatus for wireless communication at a base station is described. The apparatus may include a processor, memory coupled with the processor, and instructions stored in the memory. The instructions may be executable by the processor to cause the apparatus to transmit, to a device controlling a surface, an indication to divide the surface into a set of portions of the surface, each portion of the set of portions associated with a different reflected beam and a different frequency shift, transmit, to a UE via the surface, one or more SSBs for each beam of a set of multiple beams, receive, from the UE, a random access preamble during a random access occasion based on the transmitting of the one or more SSBs for each beam of the set of multiple beams, and transmit, to the device controlling the surface, an indication of a reconfiguration for the surface for reflecting communications between the base station and the UE based on the receiving of the random access preamble during the random access occasion.

Another apparatus for wireless communication at a base station is described. The apparatus may include means for transmitting, to a device controlling a surface, an indication to divide the surface into a set of portions of the surface, each portion of the set of portions associated with a different reflected beam and a different frequency shift, means for transmitting, to a UE via the surface, one or more SSBs for each beam of a set of multiple beams, means for receiving, from the UE, a random access preamble during a random access occasion based on the transmitting of the one or more SSBs for each beam of the set of multiple beams, and means for transmitting, to the device controlling the surface, an indication of a reconfiguration for the surface for reflecting communications between the base station and the UE based on the receiving of the random access preamble during the random access occasion.

A non-transitory computer-readable medium storing code for wireless communication at a base station is described. The code may include instructions executable by a processor to transmit, to a device controlling a surface, an indication to divide the surface into a set of portions of the surface, each portion of the set of portions associated with a different reflected beam and a different frequency shift, transmit, to a UE via the surface, one or more SSBs for each beam of a set of multiple beams, receive, from the UE, a random access preamble during a random access occasion based on the transmitting of the one or more SSBs for each beam of the set of multiple beams, and transmit, to the device controlling the surface, an indication of a reconfiguration for the surface for reflecting communications between the base station and the UE based on the receiving of the random access preamble during the random access occasion.

Some examples of the method, apparatuses, and non-transitory computer-readable medium described herein may further include operations, features, means, or instructions for monitoring a set of multiple random access occasions based on each portion of the surface being associated with a different frequency shift, where different random access occasions of the set of multiple random access occasions correspond to different frequency shifts of the set of portions of the surface.

In some examples of the method, apparatuses, and non-transitory computer-readable medium described herein, the reconfiguration of the surface corresponds to the random access occasion in accordance with a mapping.

In some examples of the method, apparatuses, and non-transitory computer-readable medium described herein, the surface may be an RIS including a set of reflective elements.

### BRIEF DESCRIPTION OF THE DRAWINGS

FIGS. 1 and 2 show examples of wireless communications systems that support methods and apparatuses for initial access in accordance with examples as disclosed herein.

FIG. 3 shows an example of a one-shot initial access procedure that supports methods and apparatuses for initial access in accordance with examples as disclosed herein.

FIGS. 4 through 6 show examples of resource mappings that support methods and apparatuses for initial access in accordance with examples as disclosed herein.

FIG. 7 shows an example of a reconfigurable intelligent surface (RIS) configuration that supports methods and apparatuses for initial access in accordance with examples as disclosed herein.

FIGS. 8 and 9 show examples of process flows that support methods and apparatuses for initial access in accordance with examples as disclosed herein.

FIGS. 10 and 11 show block diagrams of devices that support methods and apparatuses for initial access in accordance with examples as disclosed herein.

FIG. 12 shows a block diagram of a communications manager that supports methods and apparatuses for initial access in accordance with examples as disclosed herein.

FIG. 13 shows a diagram of a system including a device that supports methods and apparatuses for initial access in accordance with examples as disclosed herein.

FIGS. 14 and 15 show block diagrams of devices that support methods and apparatuses for initial access in accordance with examples as disclosed herein.

FIG. 16 shows a block diagram of a communications manager that supports methods and apparatuses for initial access in accordance with examples as disclosed herein.

FIG. 17 shows a diagram of a system including a device that supports methods and apparatuses for initial access in accordance with examples as disclosed herein.

FIGS. 18 through 21 show flowcharts illustrating methods that support methods and apparatuses for initial access in accordance with examples as disclosed herein.

### DETAILED DESCRIPTION

In some systems, two or more devices may communicate with each other over a radio frequency band associated with a relatively high path loss. To mitigate the adverse impacts of the relatively high path loss on a coverage range of the two devices, the two devices may employ a beamforming technique according to which each of the two devices align transmission and reception in specific directions. In some deployment scenarios, direct beamforming between the two devices may still be insufficient and fail to support a reliable communication link between the two devices. In some of such deployment scenarios in which direct beamforming between the two devices is insufficient for a reliable communication link between the two devices, the two devices may use an assisting device, such as a reconfigurable intelligent surface (RIS), to support the communication link between the devices. An RIS, which may be an example of a reflective surface, may be associated with a number of different configurations, where each of the different configurations corresponds to a unique pair of a receive beam at the RIS and a reflected beam from the RIS.

To support a one-shot initial access procedure between two devices, such as between a base station and a user equipment (UE), the base station may divide an RIS into a number of sub-RISs, each sub-RIS configured to have a common receive beam oriented toward the base station and different reflected beams oriented toward potential locations of the UE. As part of the one-shot initial access procedure, the base station may transmit a synchronization signal block (SSB) using each of a number of SSB beams and at least one of the SSBs may hit the surface of the RIS. The RIS may reflect the SSB via a number of different reflected beams in accordance with the configurations of the sub-RISs and, in some scenarios, at least one of the reflected beams may reach the UE. In some systems, the UE may transmit random access signaling based on which SSB beam the UE measures to have a suitable signal strength (such that the random access signaling implicitly conveys which SSB beam the UE measures to have a suitable signal strength). In the scenario of one-shot initial access involving the RIS with a number of sub-RISs, however, the UE may be unaware of which sub-RIS was able to reflect signaling to the UE and thus unable to transmit random access signaling to implicitly indicate which reflected beam from the RIS is suitable for the UE.

In some implementations of the present disclosure, a UE and a base station may support one or more signaling- or configuration-based mechanisms according to which the UE or the base station, or both, identify which sub-RIS suitably reflects signaling from the base station to the UE via a one-shot initial access procedure. In some implementations, the base station may configure each sub-RIS to have a different frequency shift and may transmit, to the UE, a parameter indicating a quantity of synchronization rasters associated with each SSB beam, where the quantity of synchronization rasters is based on a quantity of sub-RISs. As such, the UE may monitor for SSBs over different monitoring occasions corresponding to the quantity of synchronization rasters for each SSB beam, identify which synchronization raster of which SSB beam provides a suitable signal strength, and transmit random access signaling to the base station based on the identified synchronization raster and SSB beam. Additionally or alternatively, the base station may use the different frequency shifts of the different sub-RISs to identify from which sub-RIS random access signaling from the UE is reflected. For example, the base station may monitor over a quantity of random access occasions based on the quantity of sub-RISs (and based on respective frequency shifts of the different sub-RISs) and identify which sub-RIS reflects the random access signaling from the UE based on over which random access occasion the base station receives the random access signaling.

Particular implementations of the subject matter described in this disclosure can be implemented to realize one or more of the following potential advantages. For example, as a result of supporting the use of one-shot initial access in deployment scenarios involving an RIS, communicating devices achieve greater connectivity with lower latency. Further, the implementations described herein provide for adaptive or dynamic control between various procedures according to which a UE transmits random access signaling to convey information relating to a beam pair link with a base station (e.g., via an RIS), which may support greater adaptability to conditions or constraints of the specific UE. Moreover, greater connectivity and adaptability may lead to more reliable and robust communication in deployments involving an RIS, which may further result in better coverage (e.g., larger coverage areas). Due to such greater reliability and robustness and better coverage, communicating devices may further experience greater spectral efficiency, higher data rates, and increased system capacity, among other benefits.

Aspects of the disclosure are initially described in the context of wireless communications systems. Aspects of the disclosure are additionally illustrated by and described with reference to a one-shot initial access procedure, resource mappings, an RIS configuration, and process flows. Aspects of the disclosure are further illustrated by and described with reference to apparatus diagrams, system diagrams, and flowcharts that relate to one-shot initial access.

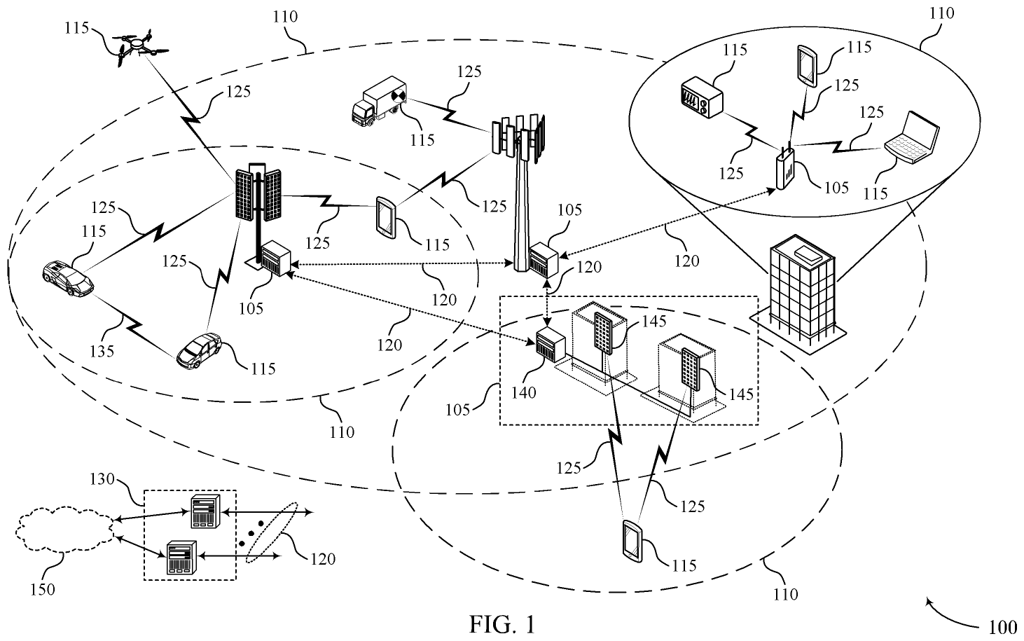

FIG. 1 shows an example of a wireless communications system 100 that supports methods and apparatuses for initial access in accordance with examples as disclosed herein. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a geographic coverage area 110 over which the UEs 115 and the base station 105 may establish one or more communication links 125. The geographic coverage area 110 may be an example of a geographic area over which a base station 105 and a UE 115 may support the communication of signals according to one or more radio access technologies.

The UEs 115 may be dispersed throughout a geographic coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, base station 105, entity of a core network 130, apparatus, device, or computing system configured to perform any techniques described herein. For example, a network node may be a UE 115. As another example, a network node may be a base station 105. As another example, a first network node may be configured to communicate with a second network node or a third network node. In one aspect of this example, the first network node may be a UE 115, the second network node may be a base station 105, and the third network node may be a UE 115. In another aspect of this example, the first network node may be a UE 115, the second network node may be a base station 105, and the third network node may be a base station 105. In yet other aspects of this example, the first, second, and third network nodes may be different. Similarly, reference to a UE 115, a base station 105, an apparatus, a device, or a computing system may include disclosure of the UE 115, base station 105, apparatus, device, or computing system being a network node. For example, disclosure that a UE 115 is configured to receive information from a base station 105 also discloses that a first network node is configured to receive information from a second network node. In this example, consistent with this disclosure, the first network node may refer to a first UE 115, a first base station 105, a first apparatus, a first device, or a first computing system configured to receive the information; and the second network node may refer to a second UE 115, a second base station 105, a second apparatus, a second device, or a second computing system.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may include one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, such as in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS), or an SSB), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

In some systems, such as the wireless communications system 100, two or more devices may communicate with each other over a radio frequency band associated with a relatively high path loss. For example, two devices may attempt to communicate with each other over an FR2, such as from about 24.25 GHz to about 52.6 GHz, or mmW, such as from about 24 GHz to about 100 GHz, radio frequency band. To mitigate the adverse impacts of the relatively high path loss on a coverage range of the two devices, the two devices may employ a beamforming technique according to which each of the two devices align transmission and reception in specific directions. For example, the two devices may apply beam weights to one or more antenna elements or panels to align reception or transmission of wireless signaling in one of various directions. A link between two communicating devices established via beamforming may be referred to herein as a beam pair link. A beam pair link may refer to or include a first beam and a second beam, where the first beam may be used by a first device to transmit to or receive from a second device and the second beam may be used by the second device to transmit to or receive from the first device.

In some deployment scenarios, direct beamforming between the two devices may still be insufficient and fail to support a reliable communication link between the two devices. In some of such deployment scenarios in which direct beamforming between the two devices is insufficient for a reliable communication link between the two devices, the two devices may use an assisting device, such as an RIS, to support the communication link between the devices. An RIS, which may be an example of a reflective surface, may be associated with a number of different configurations, where each of the different configurations corresponds to a unique pair of a receive beam at the RIS and a reflected beam from the RIS.

To support a one-shot initial access procedure between two devices, such as between a base station 105 and a UE 115, the base station 105 may divide an RIS into a number of sub-RISs, each sub-RIS configured to have a common receive beam oriented toward the base station 105 and different reflected beams oriented toward potential locations of the UE 115. As part of the one-shot initial access procedure, the base station 105 may transmit an SSB for each of a number of SSB beams and at least one of the SSBs may hit the surface of the RIS. The RIS may reflect the SSB via a number of different reflected beams in accordance with the configurations of the sub-RISs and, in some scenarios, one of the reflected beams may reach the UE 115.

In some systems, the UE 115 may transmit random access signaling based on which SSB beam the UE 115 measures to have a suitable signal strength (such that the random access signaling implicitly conveys which SSB beam the UE 115 measures to have a suitable signal strength). Such a suitable signal strength may refer to a greatest measured signal strength relative to other SSB beam measurements or a signal strength that satisfies (such as is greater than) a threshold signal strength. To support such an implicit indication of an SSB beam via random access signaling, the base station 105 may provide the UE 115 with an association between SSB beams and random access channel (RACH) occasions via control signaling, such as via a system information block (SIB) (e.g., SIB1).

In some examples, the UE 115 may receive, from the base station 105, an indication of an association between SSB beams and RACH occasions (and the association may lack information relating to a mapping between RIS configurations and RACH occasions). Using the association, the UE 115 may transmit a random access preamble to the base station 105 during a RACH occasion corresponding to an SSB beam which the UE 115 measures to have a greatest signal strength or a signal strength that otherwise satisfies a threshold signal strength to implicitly indicate which SSB beam the base station 105 may use to communicate with the UE 115. If multiple SSB beams are mapped to a same RACH occasion in accordance with the association, the base station 105 and the UE 115 may partition a set of available random access preambles to distinguish a selected SSB beam from others of the multiple SSB beams. For example, if two SSB beams are mapped to a same RACH occasion, any preamble from a first subset of random access preambles may be indicate a first SSB beam and any preamble from a second subset of random access preambles may indicate a second SSB beam.

For example, the base station 105 may provide the UE 115 with a servingCellConfigCommon information element including or indicating an initialUplinkBWP information element, which may in turn include or indicate a RACH-ConfigCommon information element. The RACH-ConfigCommon information element may include a msg1-FDM parameter (which may be a value of one, two, four, or eight) that may indicate how many RACH occasions can be multiplexed in frequency and an ssb-perRACH-OccasionAndCB-PreamblesPerSSB parameter (which may have a value of one-eighth, one-fourth, one-half, one, two, four, eight, or sixteen) that may indicate a mapping from SSB monitoring occasions to RACH occasions or random access preambles, or a combination of RACH occasions and random access preambles. For example, for ssb-perRACH-OccasionAndCB-PreamblesPerSSB=1, one SSB beam index corresponds to one RACH occasion. For further example, for ssb-perRACH-OccasionAndCB-PreamblesPerSSB=8, eight SSB beam indices correspond to one RACH occasion.

In the scenario of one-shot initial access involving the RIS with a number of sub-RISs, however, the UE 115 may be unaware of which sub-RIS was able to reflect signaling to the UE 115 and thus unable to transmit random access signaling to implicitly indicate which reflected beam from the RIS is most suitable for the UE 115. Further, some access procedures (e.g., including one-shot access procedures) involving more than one RIS may lack scalability, as beam sweeping and complexity costs may become prohibitively high.

In some implementations of the present disclosure, a UE 115 and a base station 105 may support one or more signaling- or configuration-based mechanisms according to which the UE 115 or the base station 105, or both, may identify which sub-RIS suitably reflects signaling from the base station to the UE 115 via a one-shot initial access procedure between the UE 115 and the base station 105. In some implementations, the base station 105 may configure each sub-RIS to have a different frequency shift and may transmit, to the UE 115, a parameter indicating a quantity of synchronization rasters associated with each SSB beam, where the quantity of synchronization rasters is based on a quantity of sub-RISs. As such, the UE 115 may monitor for SSBs over different monitoring occasions corresponding to the quantity of synchronization rasters for each SSB beam, identify which synchronization raster of which SSB beam provides a suitable signal strength, and transmit random access signaling to the base station 105 based on the identified synchronization raster and SSB beam.

Additionally or alternatively, the base station 105 may use the different frequency shifts of the different sub-RISs to identify from which sub-RIS random access signaling from the UE 115 is reflected. For example, the base station 105 may monitor over a quantity of random access occasions based on the quantity of sub-RISs (and based on the respective frequency shifts of the different sub-RISs) and identify which sub-RIS reflected the random access signaling from the UE 115 based on over which random access occasion the base station 105 receives the random access signaling.

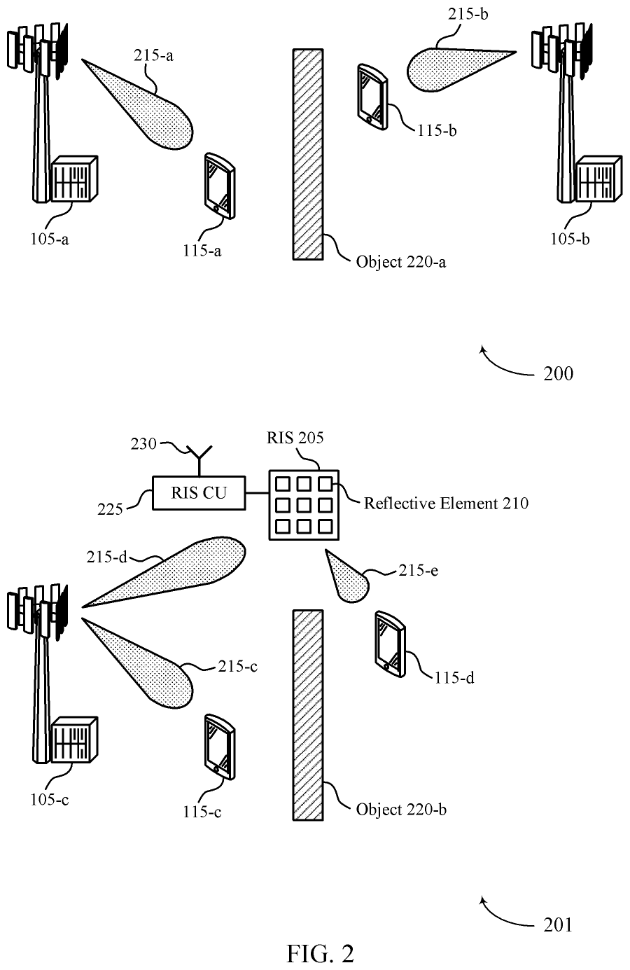

FIG. 2 shows examples of wireless communications systems 200 and 201 that support methods and apparatuses for initial access in accordance with examples as disclosed herein. The wireless communications systems 200 and 201 may implement or be implemented to realize aspects of the wireless communications system 100. For example, the wireless communications systems 200 and 201 both illustrate communication between one or more UEs 115 and one or more base stations 105, which may be examples of corresponding devices described herein, including with reference to FIG. 1. In some implementations, a UE 115 and a base station 105 may participate in a one-shot initial access procedure involving an RIS 205 in accordance with the examples disclosed herein.

Some systems may employ massive MIMO (such as 5G massive MIMO) to increase an achievable throughput between two communicating devices, and such systems may extend coverage via one or more active antenna units or one or more passive reflective surfaces (such as RISs), or any combination thereof. For example, and as illustrated by the wireless communications system 200 in which a base station 105-a transmits to a UE 115-a via a beam 215-a and a base station 105-b transmits to a UE 115-b via a beam 215-b, some systems may achieve a relatively higher beamforming gain by using active antenna units. In some aspects, such active antenna units may be associated with a use of individual radio frequency chains per antenna ports. Such systems may experience a significant increase in power consumption due to the use of active antenna units.

For example, the wireless communications system 200 may include an object 220-a that blocks or otherwise inhibits a line-of-sight (LoS) link between the base station 105-a and the UE 115-b. As such, the wireless communications system 200 may include the base station 105-b, supporting an active antenna unit, to support wireless communications with the UE 115-b (as the base station 105-a may be unable to support wireless communications with the UE 115-b due to a location of the object 220-a and a location of the UE 115-b). Thus, to support wireless communications with both the UE 115-a and the UE 115-b, the wireless communications system 200 may deploy two base stations 105 each operating separate active antenna units, which may be associated with an increase in power consumption. Further, although illustrated to show two base stations 105, the wireless communications system 200 may additionally or alternatively deploy one or more other devices capable of supporting an active antenna unit, such as a relay node or a smart repeater, to support wireless communications with both the UE 115-a and the UE 115-b.

Some systems (such as the wireless communications system 201) may, in addition or as an alternative to deploying additional active antenna units, employ the use of one or more assisting devices, such as one or more RISs 205, to extend coverage (such as 5G coverage) with a negligible or relatively small increase in power consumption. In other words, some systems (e.g., including the wireless communications system 201) may leverage passive MIMO as a substitute for an active antenna unit. For example, an RIS 205 may be a near-passive device capable of reflecting an impinging or incident wave to a desired location or in a desired direction.

As illustrated in the wireless communications system 201, for example, a base station 105-c may use an RIS 205 to reflect communications from the base station 105-c via a beam 215-d (directed to the RIS 205) to a UE 115-d via a beam 215-e (directed from the RIS 205 to the UE 115) to avoid an object 220-b. As such, the base station 105-c (e.g., a single base station 105 operating an active antenna unit) may communicate (directly) with a UE 115-c via a beam 215-c and may communicate (indirectly, due to a location of the object 220-b and the UE 115-d) with the UE 115-d via the RIS 205. A node or CU, such as an RIS CU 225, may configure a reflection characteristic of the RIS 205 to control the reflection direction from the RIS 205 and, in some aspects, a base station 105 may configure or control the node or CU (such that the base station 105 may effectively configure or control the reflection direction of the RIS 205). For example, a base station 105-c may transmit messaging to the RIS CU 225 indicating a configuration of the RIS 205 and the RIS CU 225 may configure the RIS 205 accordingly. In some aspects, a configuration of the RIS 205 may be associated with a receive beam, such as a directional beam or configuration for directional “reception” of signaling, and a reflected beam, such a directional beam or configuration for directional reflection of the signaling. Further, although described herein as a “receive” beam, a receive beam associated with a configuration of the RIS 205 may refer to reception as part of a reflecting (as opposed to, for example, as part of a decoding).

An RIS 205 may function similarly to a mirror or other reflective surface in its ability to reflect incident beams or waves (such as light waves), but may differ in that an RIS 205 may include one or more components that are able to control or dictate how an incident beam or wave is reflected (such that an angle of incidence can be different than an angle of reflection) or that are able to control or dictate a shape of a reflected beam or wave (such as via energy focusing or energy nulling via constructive interference or destructive interference, respectively), or both. For example, an RIS 205 may include a quantity of reflective elements 210 that each have a controllable delay, phase, or polarization, or any combination thereof, and the RIS CU 225 may control or configure each of the reflective elements 210 to control how an incident beam or wave is reflected or to control a shape of a reflected beam or wave. An RIS 205 may be an example of or may otherwise be referred to as a software-controlled metasurface, a configurable reflective surface, a reflective intelligent surface, or a configurable intelligent surface, and may sometimes be a metal surface (such as a copper surface) including a quantity of reflective elements 210. In some aspects, an RIS CU 225 may be coupled with an RIS 205 via hardware (such as via a fiber optic cable). In some other aspects, an RIS CU 225 may be non-co-located with an RIS 205 and may configure the RIS 205 via over-the-air signaling.

In some aspects, the RIS CU 225 may have both transmission and reception capability via one or more antennas 230. The RIS CU 225 may use its transmission and reception capability to assist in establishing an RRC connection between the base station 105-c and the RIS CU 225. For example, the base station 105-c may sweep over a set of SSB beams and the RIS CU 225 may measure each of the set of SSB beams and respond with a RACH preamble corresponding to a strongest of the set of SSB beams. As such, the base station 105-c may learn (based on receiving the RACH preamble response from the RIS CU 225) which beam to use to communicate with the RIS CU 225. The base station 105-c may use the same beam to transmit signaling to the RIS 205 (such as to “light up” a surface of the RIS 205), which may support or otherwise facilitate a configuration of the RIS 205, by the base station 105-c, such that a receive beam of the RIS 205 is oriented toward the base station 105-c.

In accordance with the implementations described herein, the base station 105-c may attempt a one-shot initial access procedure with the UE 115-d via the RIS 205. For example, the base station 105-c may transmit an SSB using each of a set of beams (such as SSB beams) and at least one of the beams may be oriented toward the RIS 205. As such, the RIS 205 may reflect an SSB via one or more reflected beams in accordance with a configuration of the RIS 205. In some aspects, the base station 105 may configure the RIS 205 such that the RIS 205 includes or otherwise supports a number of sub-RISs, each sub-RIS associated with a respective configuration (e.g., a respective reflected beam toward potential or candidate locations of the UE 115-d). In some implementations, the UE 115-d, the RIS 205, or the base station 105-c, or any combination thereof, may support one or more signaling- or configuration-based mechanisms to facilitate an obtaining of knowledge as to which sub-RIS of the RIS 205 is able to reflect signaling (e.g., an SSB) to the UE 115-d. In some aspects, the one or more signaling- or configuration-based mechanisms may be associated with or otherwise involve the use of random access signaling between the UE 115-d and the base station 105-c.

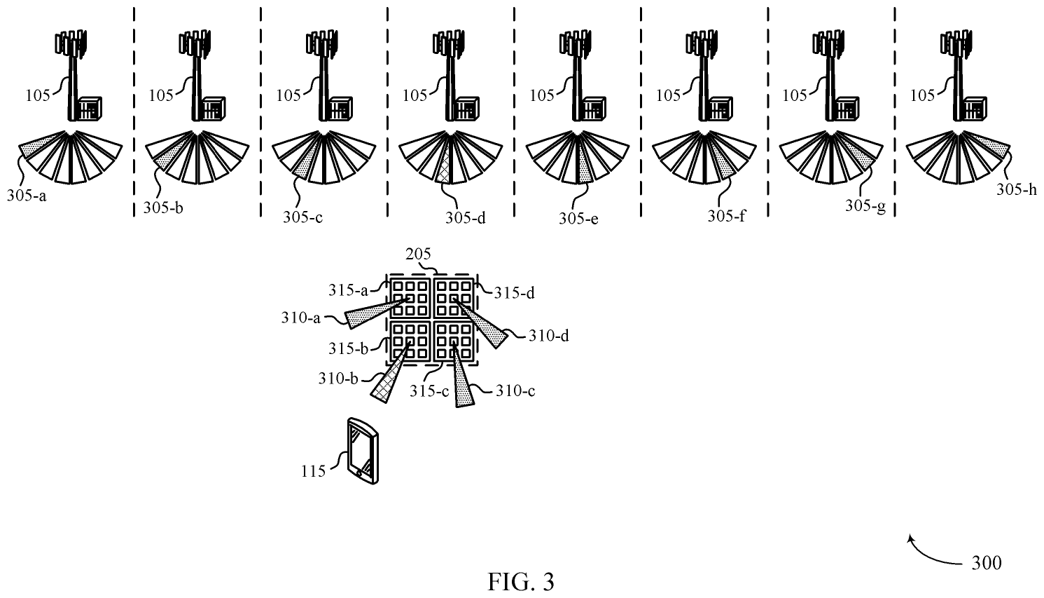

FIG. 3 shows an example of a one-shot initial access procedure 300 that supports methods and apparatuses for initial access in accordance with examples as disclosed herein. The one-shot initial access procedure 300 may implement or be implemented to realize aspects of the wireless communications system 100, the wireless communications system 200, or the wireless communications system 201. For example, the one-shot initial access procedure 300 illustrates a beam planning between a base station 105 and a UE 115 via an RIS 205, which may be examples of corresponding devices described herein, including with reference to FIGS. 1 and 2.

As part of the one-shot initial access procedure 300, the base station 105 may transmit one or more reference signals, such as one or more SSBs, via each of a set of beams 305 (which may be examples of SSB beams). The base station 105 may transmit an SSB via a different beam 305 during each of a set of occasions associated with the one-shot initial access procedure 300. For example, the base station 105 may transmit an SSB via a beam 305-a during a first occasion, a beam 305-b during a second occasion, a beam 305-c during a third occasion, a beam 305-d during a fourth occasion, a beam 305-e during a fifth occasion, a beam 305-f during a sixth occasion, a beam 305-g during a seventh occasion, and a beam 305-h during an eighth occasion. As such, the base station 105 may cycle across eight different beams 305.

The base station 105 may perform the one-shot initial access procedure 300 in an attempt to establish a connection (e.g., a beam pair link) with the UE 115 and, in some deployment scenarios, the RIS 205 may be positioned such that the RIS 205 may receive (and likewise reflect) some SSBs from the base station 105. In some aspects, the base station 105 may transmit a configuration to the RIS 205 (or to an RIS CU 225 associated with the RIS 205) associated with a division of the RIS 205 into a number of portions. Such portions may be referred to herein as sub-RISs 315 and the base station 105 may indicate a different reflection configuration for each sub-RIS 315.

For example, in accordance with configuration signaling from the base station 105, the RIS 205 may divide itself into a sub-RIS 315-a associated with a first reflection configuration, a sub-RIS 315-b associated with a second reflection configuration, a sub-RIS 315-c associated with a third reflection configuration, and a sub-RIS 315-d associated with a fourth reflection configuration. In some aspects, each of the reflection configurations of the sub-RISs 315 may be associated with a same receive beam for receiving signaling from the base station 105 (such that each sub-RIS 315 is able to receive signaling from the base station 105 via the beam 305-d, as shown in FIG. 3) and different reflected beams 310. For example, the sub-RIS 315-a may reflect signaling via a reflected beam 310-a, the sub-RIS 315-b may reflect signaling via a reflected beam 310-b, the sub-RIS 315-c may reflect signaling via a reflected beam 310-c, and the sub-RIS 315-d may reflect signaling via a reflected beam 310-d.

As such, for one-shot initial access for an RIS-based or -associated deployment, it is possible that the UE 115 may receive one or more SSBs via a reflection off the RIS 205 instead of or in addition to receiving one or more SSBs directly from the base station 105 (e.g., without reflection off the RIS 205). Further, the UE 115 may be unaware of the configurations of each of the sub-RISs 315 or unaware of how to distinguish between different reflected beams 310 associated with different sub-RISs 315, or unaware of both. For example, the UE 115 may receive an SSB via the reflected beam 310-b during the fourth occasion (which the UE 115 may know to be associated with the beam 305-d from the base station 105 in accordance with a configuration of a beam sweeping procedure between the UE 115 and the base station 105) but may be unaware of which sub-RIS 315 is associated with the reflected beam 310-b or if the received SSB was reflected off the RIS 205 at all. As such, the UE 115 may be unable to assist the base station 105 with a configuration of the RIS 205, as the UE 115 may be unable to provide the base station 105 with any information relating to which sub-RIS 315 (and, by extension, which RIS configuration) is able to reflect signaling to the UE 115.

In some implementations, the UE 115 and the base station 105 may leverage different frequency shifts or offsets associated with each of the sub-RISs 315 to enable the UE 115 to obtain, measure, or report information relating to which sub-RIS 315 reflects an SSB to the UE 115. For example, the base station 105 may configure each sub-RIS 315 to be associated with a different frequency shift in their respective reflected directions and the UE 115 may monitor different rasters in frequency for each of a number of time domain occasions of the one-shot initial access procedure 300 to identify which beam 305 and which sub-RIS 315 provides a strongest or otherwise suitable signal strength at the UE 115. In accordance with the configuration from the base station 105, for example, the sub-RIS 315-a may be associated with a frequency shift f₀ in the direction of the reflected beam 310-a, the sub-RIS 315-b may be associated with a frequency shift f₁ in the direction of the reflected beam 310-b, the sub-RIS 315-c may be associated with a frequency shift f₂ in the direction of the reflected beam 310-c, and the sub-RIS 315-d may be associated with a frequency shift f₃ in the direction of the reflected beam 310-d.

In examples in which the RIS 205 supports four sub-RISs 315, the UE 115 may accordingly monitor four rasters in frequency (e.g., across various occasions of the one-shot initial access procedure 300). The UE 115 may measure a signal strength over each of the four rasters in time or frequency for each beam 305 and may report, to the base station 105, a strongest raster and a strongest beam index (corresponding to one of the beams 305 from the base station 105), where different rasters correspond to different sub-RISs 315 or a direct link between the UE 115 and the base station 105. As such, and in accordance with the example of FIG. 3, the base station 105 may identify that the sub-RIS 315-b reflected an SSB toward the UE 115 and may configure the RIS 205 accordingly (such that an entirety of the RIS 205 is configured with a same RIS configuration used by the sub-RIS 315-b).

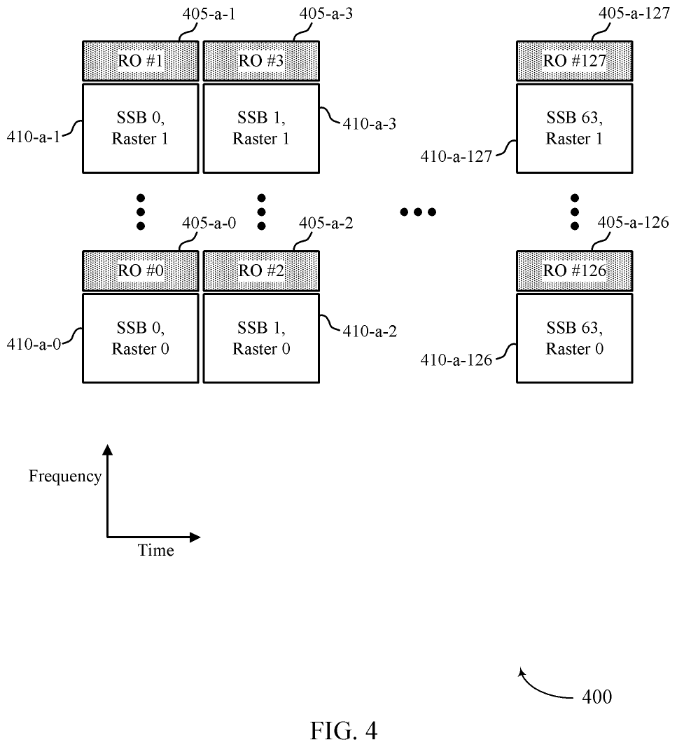

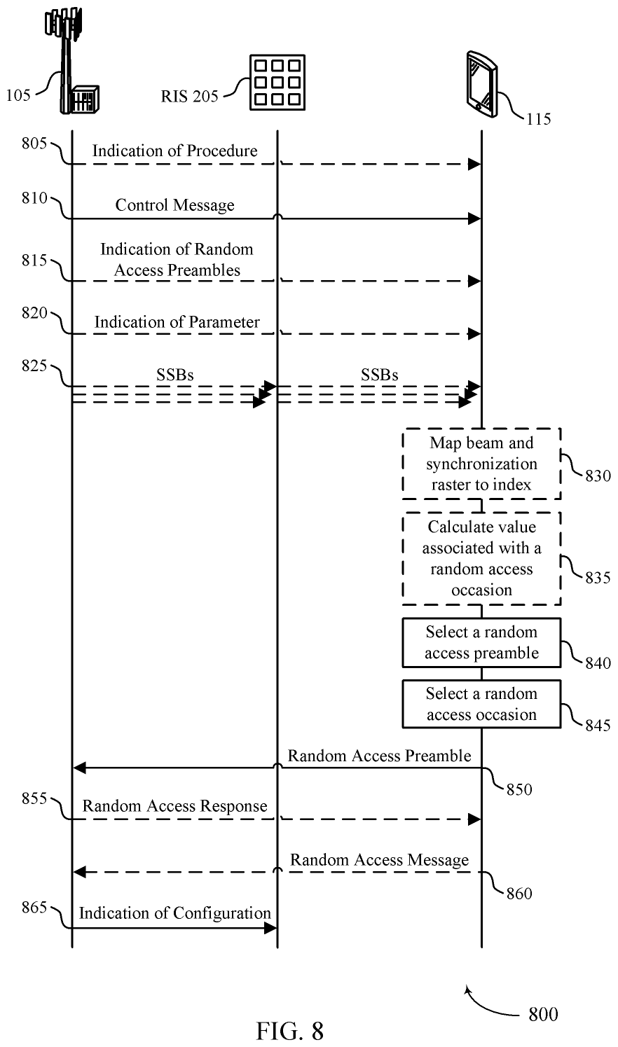

In some implementations, the UE 115 may report the identified raster and beam index to the base station 105 via random access signaling. In some examples, for instance, the UE 115 may select a random access occasion based on the identified raster and beam index and may transmit a random access preamble during the selected random access occasion. Additional details relating to such a selection of a random access occasion based on the identified raster and beam index are illustrated by and described with reference to FIGS. 4 through 6. In some other examples, the UE 115 may select both a random access occasion and a random access preamble based on the identified raster and beam index and may transmit the selected random access preamble during the selected random access occasion. Additional details relating to such a selection of a random access occasion and a random access preamble are illustrated by and described with reference to FIG. 8.

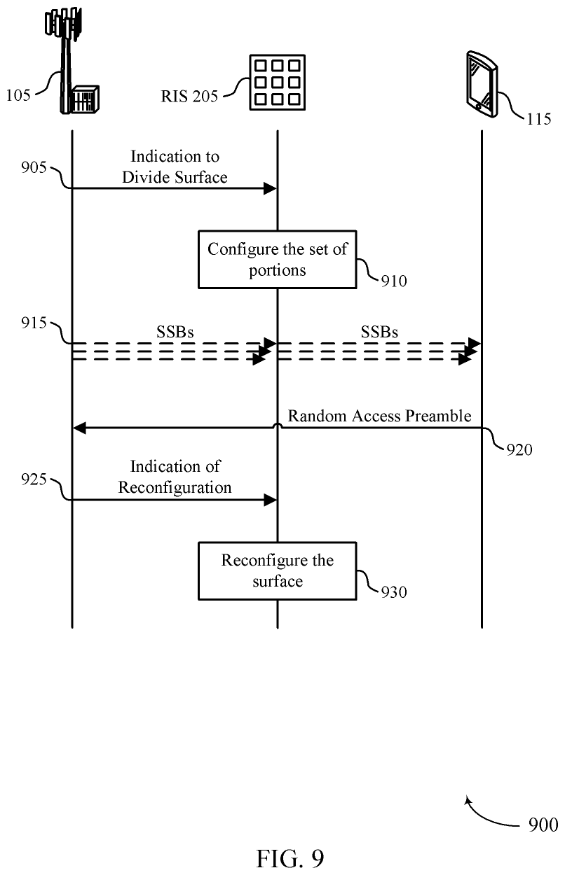

In some other examples, the base station 105 may leverage the different frequency shifts associated with the different sub-RISs 315 for uplink signaling from the UE 115 and may identify an RIS configuration in accordance with a frequency shift associated with random access signaling from the UE 115 (as imparted on the random access signaling by a specific sub-RIS 315). Additional details relating to such a use of the different frequency shifts associated with the different sub-RISs 315 for uplink signaling are illustrated by and described with reference to FIG. 9. Further, although illustrated and described as supporting four sub-RISs 315, an RIS 205 may support any number of sub-RISs 315. Further, although shown as including one RIS 205, the one-shot initial access procedure 300 may support any number of RISs 205. For example, sub-RISs 315 across different RISs 205 may be configured with different frequency shifts to support the implementations disclosed herein.

FIG. 4 shows an example of a resource mapping 400 that supports methods and apparatuses for initial access in accordance with examples as disclosed herein. The resource mapping 400 may implement or be implemented to realize aspects of the wireless communications system 100, the wireless communications system 200, the wireless communications system 201, or the one-shot initial access procedure 300. For example, a UE 115 and a base station 105 may support the resource mapping 400 to facilitate a correspondence or association between RACH occasions 405-a (which may be denoted as an “RO” in FIG. 4) and monitoring occasions 410-a. Further, RACH occasions 405 and monitoring occasions 410 as illustrated by and described with reference to FIGS. 4 through 6 may refer to areas or allocations of time-frequency resources, but actual locations of the corresponding time-frequency resources may or may not be shown. Instead, FIGS. 4 through 6 may illustrate a correspondence or mapping between RACH occasions 405 and monitoring occasions 410 via proximity and corresponding numbering.

In accordance with the implementations disclosed herein, the UE 115 may receive an indication of a quantity of synchronization rasters for each beam (e.g., for each SSB beam) and may monitor over a quantity of monitoring occasions 410-a for each beam accordingly. Further, the UE 115 may determine a location (e.g., in time and frequency) for each of the quantity of monitoring occasions 410-a in accordance one or both of a signaled or configured starting frequency location or a signaled or configured frequency offset or spacing between different monitoring occasions 410-a. In some aspects, such a frequency offset or spacing between different monitoring occasions 410-a may be associated with (e.g., equal to) a frequency shift between sub-RISs 315. The UE 115 may receive an indication of the quantity of synchronization rasters for each beam from the base station 105 via a parameter (e.g., an RRC parameter). For example, the UE 115 may receive a Num-rasters parameter in a RACH-ConfigCommon information element and the Num-rasters parameter may indicate the quantity of synchronization rasters for each beam.

In the example of the resource mapping 400, the RACH-ConfigCommon information element may indicate Num-rasters=2, msg1-FDM=1, and ssb-perRACH-OccasionAndCB-PreamblesPerSSB=1. As such, the UE 115 may monitor or measure during two monitoring occasions 410-a for each beam and monitoring occasions 410-a associated with different SSB beams may lack or be absent of multiplexing in the frequency domain. For example, and as shown in FIG. 4, the UE 115 may monitor a monitoring occasion 410-a-0 for an SSB associated with an SSB index 0 and a first synchronization raster (e.g., a raster index 0) and a monitoring occasion 410-a-1 for an SSB associated with the SSB index 0 and a second synchronization raster (e.g., a raster index 1). Similarly, the UE 115 may monitor a monitoring occasion 410-a-2 for an SSB associated with an SSB index 1 and the first synchronization raster (e.g., the raster index 0) and a monitoring occasion 410-a-3 for an SSB associated with the SSB index 1 and the second synchronization raster (e.g., the raster index 1). The UE 115 may similarly monitor two monitoring occasions (one for the first synchronization raster and one for the second synchronization raster) for each SSB beam sent by the base station 105. For example, the UE 115 may also monitor for SSBs during monitoring occasions 410-a-4 through 410-a-127 (monitoring occasions 410-a-4 through 410-a-125 not shown) in accordance with Num-rasters=2 and msg1-FDM=1.

As a result of the monitoring, the UE 115 may identify during which monitoring occasion 410-a the UE 115 measures an SSB having a suitable signal strength (such as a greatest signal strength or a signal strength that satisfies a threshold signal strength) and the UE 115 may select a RACH occasion 405-a accordingly. For example, the UE 115 may select a RACH occasion 405-a corresponding to the identified monitoring occasion 410-a in accordance with the resource mapping 400. As shown in FIG. 4, the resource mapping 400 may define a correspondence or association between the monitoring occasion 410-a-0 and a RACH occasion 405-a-0, between the monitoring occasion 410-a-1 and a RACH occasion 405-a-1, between the monitoring occasion 410-a-2 and a RACH occasion 405-a-2, between the monitoring occasion 410-a-3 and a RACH occasion 405-a-3, and so on through to between the monitoring occasion 410-a-127 and a RACH occasion 405-a-127.

As such, the UE 115 may select a RACH occasion 405-a in accordance with during which monitoring occasion 410-a the UE 115 measures a greatest or otherwise suitable signal strength. In some aspects, the UE 115 may receive an indication of the resource mapping 400 from the base station 105 (e.g., via a RACH-ConfigCommon information element). Additionally or alternatively, the resource mapping 400 may be pre-configured (e.g., pre-loaded) at the UE 115 and the base station 105.

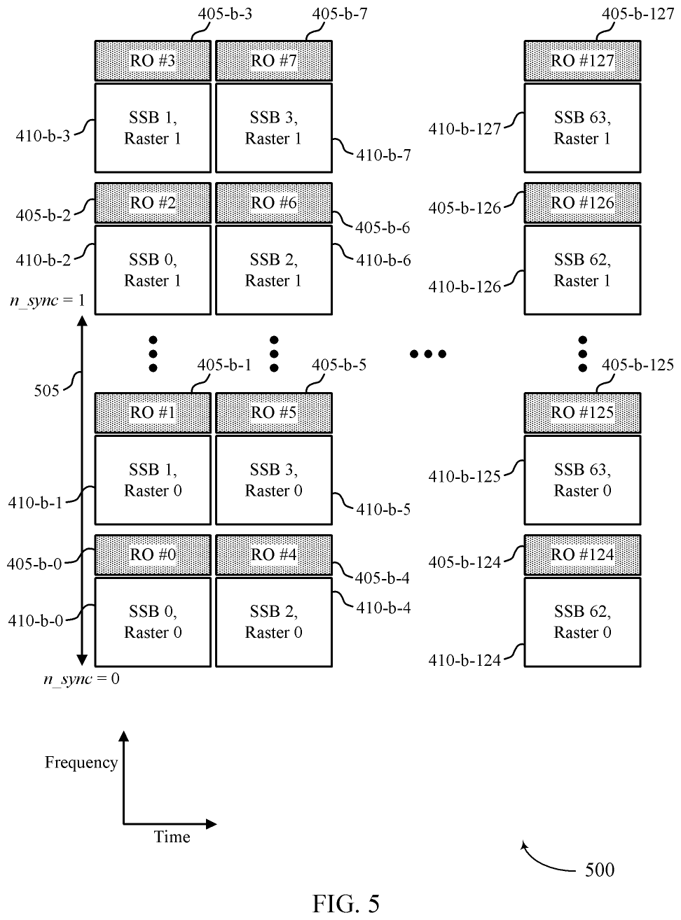

FIG. 5 shows an example of a resource mapping 500 that supports methods and apparatuses for initial access in accordance with examples as disclosed herein. The resource mapping 500 may implement or be implemented to realize aspects of the wireless communications system 100, the wireless communications system 200, the wireless communications system 201, or the one-shot initial access procedure 300. For example, a UE 115 and a base station 105 may support the resource mapping 500 to facilitate a correspondence or association between RACH occasions 405-b (which may be denoted as an “RO” in FIG. 5) and monitoring occasions 410-b.

In the example of the resource mapping 500, the RACH-ConfigCommon information element may indicate Num-rasters=2, msg1-FDM=2, and ssb-perRACH-OccasionAndCB-PreamblesPerSSB=1. As such, the UE 115 may monitor or measure during two monitoring occasions 410-b for each beam and monitoring occasions 410-b associated with two different SSB beams may be multiplexed in the frequency domain. For example, and as shown in FIG. 5, the UE 115 may monitor a monitoring occasion 410-b-0 for an SSB associated with an SSB index 0 and a first synchronization raster (e.g., a raster index 0), a monitoring occasion 410-b-1 for an SSB associated with an SSB index 1 and the first synchronization raster (e.g., the raster index 0), a monitoring occasion 410-b-2 for an SSB associated with the SSB index 0 and a second synchronization raster (e.g., a raster index 1), and a monitoring occasion 410-b-3 for an SSB associated with the SSB index 1 and the second synchronization raster (e.g., the raster index 1). The UE 115 may similarly monitor for SSBs during monitoring occasions 410-b-4 through 410-b-127 (monitoring occasions 410-b-8 through 410-b-123 not shown) in accordance with Num-rasters=2 and msg1-FDM=2.

As a result of the monitoring, the UE 115 may identify during which monitoring occasion 410-b the UE 115 measures an SSB having a suitable signal strength (such as a greatest signal strength or a signal strength that satisfies a threshold signal strength) and the UE 115 may select a RACH occasion 405-b accordingly. For example, the UE 115 may select a RACH occasion 405-b corresponding to the identified monitoring occasion 410-b in accordance with the resource mapping 500. As shown in FIG. 5, the resource mapping 500 may define a correspondence or association between the monitoring occasion 410-b-0 and a RACH occasion 405-b-0, between the monitoring occasion 410-b-1 and a RACH occasion 405-b-1, between the monitoring occasion 410-b-2 and a RACH occasion 405-b-2, between the monitoring occasion 410-b-3 and a RACH occasion 405-b-3, and so on through to between the monitoring occasion 410-b-127 and a RACH occasion 405-b-127.

As such, the UE 115 may select a RACH occasion 405-b in accordance with during which monitoring occasion 410-b the UE 115 measures a greatest or otherwise suitable signal strength. In some aspects, the UE 115 may receive an indication of the resource mapping 500 from the base station 105 (e.g., via a RACH-ConfigCommon information element). Additionally or alternatively, the resource mapping 500 may be pre-configured (e.g., pre-loaded) at the UE 115 and the base station 105.

In some implementations, the UE 115 and the base station 105 may support a separation in frequency between different RACH occasions 405-b associated with a same SSB beam index but different synchronization raster indices. For example, the UE 115 and the base station 105 may support a gap 505 between a starting point in the frequency domain for a RACH occasion 405-b associated with a first SSB beam index and a first synchronization raster index (e.g., an n_{sync}=0) and a starting point in the frequency domain for a RACH occasion 405-b associated with the first SSB beam index and a second synchronization raster index (e.g., an n_{sync}=1). In some aspects, the base station 105 may signal an indication of the gap 505 via an N_{GAP} parameter.

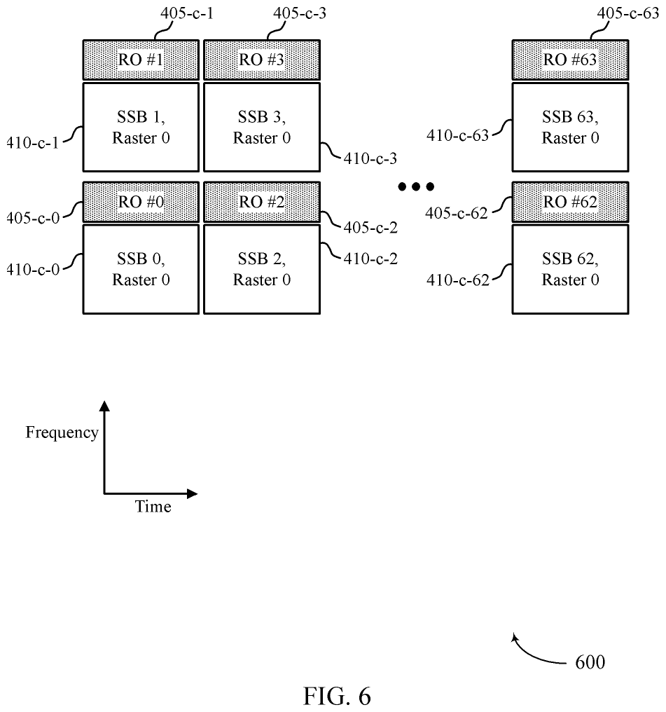

FIG. 6 shows an example of a resource mapping 600 that supports methods and apparatuses for initial access in accordance with examples as disclosed herein. The resource mapping 600 may implement or be implemented to realize aspects of the wireless communications system 100, the wireless communications system 200, the wireless communications system 201, or the one-shot initial access procedure 300. For example, a UE 115 and a base station 105 may support the resource mapping 600 to facilitate a correspondence or association between RACH occasions 405-c (which may be denoted as an “RO” in FIG. 6) and monitoring occasions 410-c.

In the example of the resource mapping 600, the RACH-ConfigCommon information element may indicate Num-rasters=1, msg1-FDM=2, and ssb-perRACH-OccasionAndCB-PreamblesPerSSB=1. As such, the UE 115 may monitor or measure during one monitoring occasion 410-c for each beam and monitoring occasions 410-c associated with two different SSB beams may be multiplexed in the frequency domain. For example, and as shown in FIG. 6, the UE 115 may monitor a monitoring occasion 410-c-0 for an SSB associated with an SSB index 0 and a first synchronization raster (e.g., a raster index 0), a monitoring occasion 410-c-1 for an SSB associated with an SSB index 1 and the first synchronization raster (e.g., the raster index 0), a monitoring occasion 410-c-2 for an SSB associated with an SSB index 2 and the first synchronization raster (e.g., the raster index 0), and a monitoring occasion 410-c-3 for an SSB associated with an SSB index 3 and the first synchronization raster (e.g., the raster index 0). The UE 115 may similarly monitor for SSBs during monitoring occasions 410-c-4 through 410-c-63 (monitoring occasions 410-c-4 through 410-c-61 not shown) in accordance with Num-rasters=1 and msg1-FDM=2.

In other words, if Num-rasters=1, the UE 115 may revert to an operation mode associated with a one-shot initial access procedure or a beam sweeping procedure without an involvement of an RIS 205. For example, if Num-rasters=1, the UE 115 may assume that there is not an RIS 205 (or at least not a relevant RIS 205) in the system and if Num-rasters>1 the UE 115 may assume that there is an RIS 205 in the system. In other words, the parameter Num-rasters may implicitly inform the UE 115 of whether there is an RIS 205 in the network and the UE 115 may monitor additional rasters for each SSB beam index accordingly.

As a result of the monitoring, the UE 115 may identify during which monitoring occasion 410-c the UE 115 measures an SSB having a suitable signal strength (such as a greatest signal strength or a signal strength that satisfies a threshold signal strength) and the UE 115 may select a RACH occasion 405-c accordingly. For example, the UE 115 may select a RACH occasion 405-c corresponding to the identified monitoring occasion 410-c in accordance with the resource mapping 600. As shown in FIG. 6, the resource mapping 600 may define a correspondence or association between the monitoring occasion 410-c-0 and a RACH occasion 405-c-0, between the monitoring occasion 410-c-1 and a RACH occasion 405-c-1, between the monitoring occasion 410-c-2 and a RACH occasion 405-c-2, between the monitoring occasion 410-c-3 and a RACH occasion 405-c-3, and so on through to between the monitoring occasion 410-c-63 and a RACH occasion 405-c-63.

As such, the UE 115 may select a RACH occasion 405-c in accordance with during which monitoring occasion 410-c the UE 115 measures a greatest or otherwise suitable signal strength. In some aspects, the UE 115 may receive an indication of the resource mapping 600 from the base station 105 (e.g., via a RACH-ConfigCommon information element). Additionally or alternatively, the resource mapping 600 may be pre-configured (e.g., pre-loaded) at the UE 115 and the base station 105. Further, and as illustrated by the resource mapping 400 and the resource mapping 500 being associated with a total of 128 RACH occasions 405 and the resource mapping 600 being associated with a total of 64 RACH occasions 405, the parameter Num-rasters may impact a total quantity of RACH occasion 405 (and likewise a total quantity of monitoring occasions 410), which may be unlike the parameter msg1-FDM (which may not impact a total quantity of RACH occasions 405 or monitoring occasions 410).

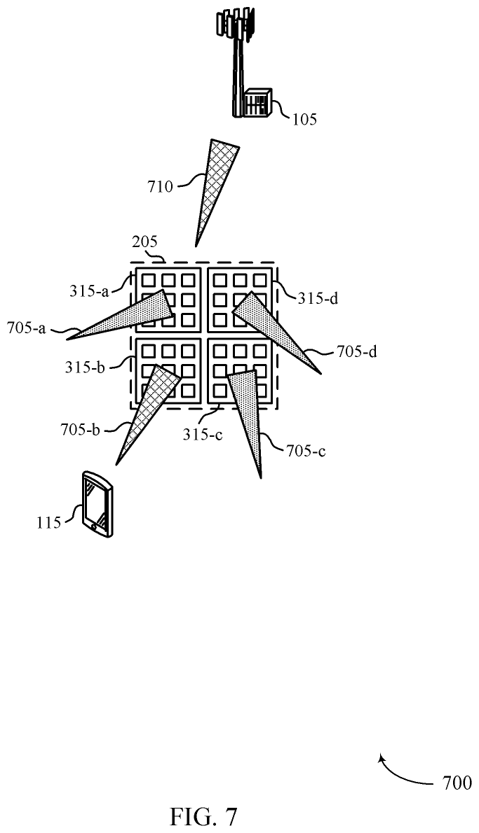

FIG. 7 shows an example of an RIS configuration 700 that supports methods and apparatuses for initial access in accordance with examples as disclosed herein. The RIS configuration 700 may implement or be implemented to realize aspects of the wireless communications system 100, the wireless communications system 200, the wireless communications system 201, or the one-shot initial access procedure 300. For example, a UE 115, an RIS 205, and a base station 105 may leverage the RIS configuration 700 to support a watermarking of random access signaling sent from the UE 115 in the uplink.

For example, with a one-shot SSB transmission via each beam 305 at the base station 105, and although a quantity of beams 305 (e.g., SSB beams) at the base station 105 may remain constant, the UE 115, the RIS 205, or the base station 105, or any combination thereof, may distinguish among different synchronization rasters (due, in part, to the frequency shifts associated with or imparted by each sub-RIS 315). To support or enable such a distinguishing among different synchronization rasters, the RIS 205 may perform watermarking in the uplink for a RACH transmission from the UE 115.

In some implementations, the base station 105 may transmit an indication to the RIS 205 (or to the RIS CU 225) for the RIS 205 to configure a quantity of sub-RISs 315 of the RIS 205 for reflecting SSB transmissions from the base station 105 and for reflecting random access signaling (e.g., a random access preamble) from the UE 115. The RIS 205 may configure each of the sub-RISs 315 with different RIS configurations. In some aspects, the indication from the base station 105 may indicate a first set of RIS configurations for the sub-RISs 315 for reflecting SSB transmissions and a second set of RIS configurations for the sub-RISs 315 for reflecting random access signaling. In some other aspects, the RIS 205 may use a same set of RIS configurations for the sub-RISs 315 for reflecting SSB transmissions and for reflecting random access signaling.

For reflecting random access signaling, each sub-RIS 315 may be associated with a different receive beam 705 but a same reflected beam 710 in accordance with the different RIS configurations employed by each sub-RIS 315. For example, the sub-RIS 315-a may be associated with a receive beam 705-a, the sub-RIS 315-b may be associated with a receive beam 705-b, the sub-RIS 315-c may be associated with a receive beam 705-c, and the sub-RIS 315-d may be associated with a receive beam 705-d. In some aspects, the receive beams 705 may be associated with same directions or orientations as the reflected beams 310, as illustrated by and described with reference to FIG. 3. In other words, each sub-RIS 315 may use a different receive beam 705 and the receive beams 705 may be the same (in terms of direction, orientation, or shape) as the reflected beams 310 associated with the sub-RISs 315 for reflecting SSB transmissions.

The UE 115 may measure one or more SSBs transmitted via different beams 305 from the base station 105 during different occasions associated with the one-shot initial access procedure 300, may identify a beam 305 (e.g., a beam i) associated with a suitable signal strength (e.g., a greatest signal strength or a signal strength that otherwise satisfies a threshold signal strength), and may transmit a random access preamble (e.g., may perform a physical random access channel (PRACH) transmission) during a RACH occasion 405 corresponding to the identified beam 305 (e.g., the beam i). In some implementations, the random access preamble may reflect off of at least one sub-RIS 315 of the RIS 205 (e.g., the sub-RIS 315-b associated with the receive beam 705-b oriented toward the UE 115) and propagate toward the base station 105 via the reflected beam 710.

The base station 105 may leverage the frequency shifts associated with each of the sub-RISs 315 to monitor multiple RACH occasions, such as RACH occasions 405, in a frequency domain (e.g., for each time-domain occasion corresponding to different beams 305). For example, the beam i may be associated with a time-domain occasion and the base station 105 may monitor a quantity of RACH occasions in the frequency domain during that time-domain occasion based on a quantity of the sub-RISs 315 and the respective frequency shifts of the sub-RISs 315 (e.g., the frequency shift f₀ of the sub-RIS 315-a, the frequency shift f₁ of the sub-RIS 315-b, the frequency shift f₂ of the sub-RIS 315-c, and the frequency shift f₃ of the sub-RIS 315-d).

As such, the base station 105 may monitor for and measure random access signaling over each of the multiple RACH occasions and may identify a RACH occasion associated with a suitable signal strength (e.g., a greatest signal strength or a signal strength that otherwise satisfies a threshold signal strength). The base station 105 may employ a mapping to identify which sub-RIS 315 suitably reflected the random access signaling from the UE 115 to the base station 105 based on which RACH occasion is associated with the suitable signal strength. In other words, the base station 105 may use the mapping to identify a strongest sub-RIS 315 and, therefore, a suitable RIS configuration (e.g., associated with a strongest receive beam 705 from the RIS 205). In some aspects, such a mapping and identification of which sub-RIS 315 suitably reflects signaling from the UE 115 to the base station 105 may be transparent to the UE 115 and instead may involve coordination and configuration exclusively between the RIS 205 and the base station 105.

In some examples, and as shown in FIG. 7, the base station 105 may identify that the sub-RIS 315-b (having an RIS configuration associated with the receive beam 705-b) is able to reflect random access signaling from the UE 115 to the base station 105 based on the base station 105 measuring a signal strength during a RACH occasion associated with the frequency shift f₁ of the sub-RIS 315-b that is greater than other signal strength measurements made over other RACH occasions associated with other sub-RISs 315. As such, the base station 105 may transmit, to the RIS 205, an indication of the RIS configuration associated with the receive beam 705-b and the RIS 205 may reconfigure itself in accordance with the indicated RIS configuration for reflecting communications between the UE 115 and the base station 105. In some aspects, and as a result of receiving the indication of the RIS configuration from the base station 105, the RIS 205 may no longer support a set of multiple sub-RISs 315 and may instead support a uniform configuration. Alternatively, the RIS 205 may maintain a set of multiple sub-RISs 315 but may configure the sub-RIS 315-b to maintain the RIS configuration associated with the receive beam 705-b.

FIG. 8 shows an example of a process flow 800 that supports methods and apparatuses for initial access in accordance with examples as disclosed herein. The process flow 800 may implement or be implemented to realize aspects of the wireless communications system 100, the wireless communications system 200, the wireless communications system 201, the one-shot initial access procedure 300, the resource mappings 400, 500, and 600, or the RIS configuration 700. In some implementations, a UE 115 and a base station 105 may participate in a one-shot initial access procedure involving an RIS 205 in accordance with the examples disclosed herein.

In the following description of the process flow 800, the operations may be performed (such as reported or provided) in a different order than the order shown, or the operations performed by the example devices may be performed in different orders or at different times. Some operations also may be omitted from the process flow 800, or other operations may be added to the process flow 800. Further, although some operations or signaling may be shown to occur at different times for discussion purposes, these operations may actually occur at the same time or otherwise concurrently.

At 805, the base station 105 may transmit, to the UE 115, an indication of a procedure according to which the UE 115 may select one or both of a random access preamble (e.g., a PRACH preamble) and a random access occasion (e.g., a RACH occasion 405) based on a quantity of synchronization rasters being associated with each of a set of beams 305 (such as SSB beams) at the base station. For example, depending on the quantity of synchronization rasters associated with each beam 305 of the set of beams 305, the UE 115 may select a random access preamble or a RACH occasion 405 according to one of various procedures and the base station 105 may indicate which procedure to use via the signaling at 805. The base station 105 may transmit such an indication of the procedure via control signaling, such as via RRC signaling (e.g., via an RRC configuration). Example procedures include a procedure associated with different synchronization rasters corresponding to different RACH occasions 405, a procedure associated with multiple synchronization rasters of a same beam 305 corresponding to a same RACH occasion 405, a procedure associated with use of a virtual SSB beam index, or a procedure associated with watermarking, by the RIS 205, in the uplink.

At 810, the base station 105 may transmit, to the UE 115, a control message indicating a quantity of synchronization rasters for each beam 305 of the set of beams 305. In some implementations, the control message may be an example of or include a servingCellConfigCommon information element, an initialUplinkBWP information element, or a RACH-ConfigCommon information element. For example, the servingCellConfigCommon information element may include or convey the initialUplinkBWP information element, which may include or convey the RACH-ConfigCommon information element. In some implementations, the RACH-ConfigCommon information element may include a Num-rasters parameter, which may indicate the quantity of synchronization rasters for each beam 305 of the set of beams 305. In some aspects, the quantity of synchronization rasters for each beam 305 may be equal to a summation of a quantity of reflected beams 310 from the RIS 205 and at least one synchronization raster associated with direct signaling from the base station 105 (e.g., without reflection from the RIS 205).

At 815, the base station 105 may transmit, to the UE 115, an indication of a set of random access preambles from which the UE 115 may select. In some implementations, such as in implementations in which multiple synchronization rasters of a beam 305 correspond to a same RACH occasion 405 (such that selection of a RACH occasion 405 alone may be insufficient to convey information about a specific synchronization raster), the set of random access preambles may be divided between the multiple synchronization rasters. For example, the base station 105 may allocate a different subset of random access preambles to each synchronization raster of the multiple synchronization rasters that correspond to the same RACH occasion 405. As such, a selection of a random access preamble (together with a selection of a RACH occasion 405) may convey sufficient information relating to a specific synchronization raster of a specific beam 305.

At 820, the base station 105 may transmit, to the UE 115, an indication of a parameter (e.g., an N_{GAP} parameter) associated with a separation in a frequency domain between different RACH occasions 405. For example, in implementations in which different synchronization rasters of a beam 305 correspond to different RACH occasions 405, the parameter may indicate a gap 505 in frequency between each of the different RACH occasions 405 associated with the beam 305. In some aspects, the UE 115 may use the parameter to calculate a value, such as a starting point in the frequency domain, associated with a RACH occasion 405.

At 825, the base station 105 may transmit, for each beam 305 of the set of beams 305, one or more SSBs. In some implementations, the base station 105 may transmit the SSBs as part of a one-shot initial access procedure between the UE 115 and the base station 105 via the RIS 205. As such, the RIS 205, which may support (e.g., be configured, by the base station 105, to support) a number of sub-RISs 315, may reflect at least one SSB in various directions in accordance with RIS configurations of the sub-RISs 315. The RIS configurations of the sub-RISs 315 may be associated with different reflected beams 310 and the UE 115 may receive an SSB via at least one of the reflected beams 310. The UE 115 may, additionally or alternatively, directly receive an SSB from the base station 105 (e.g., without reflection off the RIS 205).

To support an identification of which sub-RIS 315 or direct link provides a greatest or otherwise suitable signal strength to the UE 115, the UE 115 may measure, for each beam 305 of the set of beams 305, an SSB over a quantity of monitoring occasions 410 based on the quantity of synchronization rasters for each beam 305. In some aspects, the quantity of synchronization rasters for each beam 305 may be equal to a quantity of reflected beams 310 from the RIS 205 and at least one synchronization raster associated with direct signaling from the base station 105 (e.g., without reflection from the RIS 205). As part of the measuring, the UE 115 may determine that an SSB associated with a specific synchronization raster of a specific beam 305 has a signal strength that satisfies a signal strength threshold (e.g., has a greatest signal strength).

At 830, the UE 115 may, in some implementations, map the beam 305 and the synchronization raster that the UE 115 measures to provide a greatest signal strength to an index. For example, the UE 115 may map each (SSB beam index, synchronization raster index) pair to a (virtual) SSB beam index. In such examples, the UE 115 may employ another mapping (e.g., which may be formula- or calculation-based) between (virtual) SSB beam indices and RACH occasions 405 to select a RACH occasion 405.

At 835, the UE 115 may, in some implementations, calculate a value associated with a RACH occasion 405 based on the beam 305 and the synchronization raster. In some examples, the UE 115 may calculate the value associated with the RACH occasion 405 using the (virtual) SSB beam index identified at 830. In some systems, for example, msg1-FrequencyStart in RACH-ConfigCommon may specify a beginning of a RACH occasion 405 in the frequency domain and may be calculated in accordance with Equation 1, shown below.

$${k}_{1} = 12 {N}_{BWP , i}^{start} + 12 {n}_{RA}^{start} + 12 {n}_{RA} {N}_{RB}^{RA} - \frac{12 {N}_{grid}^{size , u}}{2} + {k}_{0}^{u} \qquad ( 1 )$$

In some aspects, n_{RA} may be non-zero if msg1-FDM>1 (and may represent a frequency offset relative to a start of an active uplink BWP), k₁ may represent a location of the RACH occasion 405 in the frequency domain, and the UE 115 or the base station 105, or both, may calculate the location of the RACH occasion 405 in the frequency domain using the (virtual) SSB beam index identified at 830. In such systems, RACH occasions 405 may be immediately adjacent in the frequency domain.

In some other examples, the UE 115 or the base station 105, or both, may calculate the value associated with the RACH occasion 405 using a variable that specifically (e.g., dedicatedly) accounts for a synchronization raster. For example, a beginning of a RACH occasion 405 in the frequency domain may, additionally or alternatively, be calculated in accordance with Equation 2, shown below.

$${k}_{1} = 12 {N}_{BWP , i}^{start} + 12 {n}_{RA}^{start} + 12 {n}_{RA} {N}_{RB}^{RA} + 12 {n}_{sync} {N}_{GAP} - \frac{12 {N}_{grid}^{size , u}}{2} + {k}_{0}^{u} \qquad ( 2 )$$

In some aspects, n_{sync}∈{0, 1, . . . , Num-rasters} and N_{GAP} may represent a gap 505 in frequency between RACH occasions 405 corresponding to different synchronization rasters. As such, different RACH occasions 405 corresponding to different synchronization rasters may not be adjacent in frequency. As shown in Equations 1 and 2, N_{BWP,i}^{start} may refer to a starting location of a BWP i, N_{grid}^{size,u} may refer to a size of a resource grid, N_{RB}^{RA} may refer to a quantity of resource blocks in a RACH occasion 405 (and may be expressed in number of resource blocks for a physical uplink shared channel (PUSCH)), n_{RA} may refer to a quantity of RACH occasions 405, n_{RA}^{start} may refer to a starting location (in frequency) for a RACH occasion 405, and k₀^{u} may be a subcarrier index relative to a reference.

At 840, the UE 115 may select a random access preamble. In some implementations, such as in implementations in which different synchronization rasters of a beam 305 correspond to different RACH occasions 405, the UE 115 may select any random access preamble from a set of available random access preambles. In some other implementations, such as in implementations in which multiple synchronization rasters of a beam 305 correspond to a same RACH occasion 405, the UE 115 may select a random access preamble from a subset of random access preambles that are allocated to the synchronization raster identified as being associated with the greatest signal strength.

At 845, the UE 115 may select a RACH occasion 405. In some implementations, the UE 115 may select the RACH occasion 405 based on the value associated with the RACH occasion 405 calculated at 835. As such, the UE 115 may select one or both of a RACH occasion 405 and a random access preamble based on a strongest beam in time and a strongest synchronization raster in frequency.

At 850, the UE 115 may transmit, to the base station 105, the selected random access preamble during the selected RACH occasion 405. As such, the UE 115 may implicitly indicate information relating to which synchronization raster of which beam 305 provides a greatest signal strength to the UE 115, where different synchronization rasters of a beam 305 correspond to different reflected beams from different sub-RISs 315 of the RIS 205.

At 855, the base station 105 may transmit, to the UE 115, a random access response associated with the random access preamble.

At 860, the UE 115 may transmit, to the base station 105, a random access message (e.g., a message 3 (msg3)). In some implementations, such as implementations in which multiple synchronization rasters of a beam 305 correspond to a same RACH occasion 405, the UE 115 may indicate the synchronization raster associated with the greatest signal strength via the random access message (e.g., via the msg3). The UE 115 may determine or identify the synchronization raster based on a (signaled or configured) correspondence or mapping between monitoring occasions 410 and synchronization rasters for a given beam 305.

In some examples, the UE 115 may provide information relating to the synchronization raster via a demodulation reference signal (DMRS) of the msg3. In such examples, the UE 115 may generate a sequence for the DMRS based on the synchronization raster (e.g., based on a synchronization raster index) and may transmit, via the msg3, the DMRS using the generated sequence. For example, the UE 115 may receive or be configured with a mapping between the signaled quantity of synchronization rasters and synchronization raster indices (such that the synchronization raster indices relate to, denote, or differentiate each of the quantity of monitoring occasions 410 that the UE 115 monitors for each beam) and may use a synchronization raster index as an initial seed value into a number generator, such as a random or pseudo-random number generator, and obtain the sequence as an output of the number generator. In some other examples, the UE 115 may provide information relating to the synchronization raster via an explicit field in the msg3. In such examples, the UE 115 may transmit an indication of the synchronization raster (e.g., of the synchronization raster index) via the field of the msg3.

At 865, the base station 105 may transmit, to the RIS 205 (or a device, such as an RIS CU 225, controlling the RIS 205), an indication of a reconfiguration of the RIS 205 for reflecting communications between the base station 105 and the UE 115. In some implementations, the reconfiguration of the RIS 205 may be based on one or both of the random access preamble and the RACH occasion 405. For example, one or both of the random access preamble and the RACH occasion 405 may be associated with a reflected beam 310 of a quantity of reflected beams 310 from the RIS 205 (in accordance with a quantity of sub-RISs 315 of the RIS 205). As such, the base station 105 may identify which reflected beam 310 is oriented toward the UE 115 in accordance with one or both of the random access preamble and the RACH occasion 405, identify a reconfiguration of a sub-RIS 315 associated with the identified reflected beam 310, and transmit an indication of the reconfiguration of the sub-RIS 315 to the RIS 205. Accordingly, the RIS 205 may reconfigure a reflection characteristic of the RIS 205 based on the reconfiguration of the sub-RIS 315 for reflecting communications between the base station 105 and the UE 115.

FIG. 9 shows an example of a process flow 900 that supports methods and apparatuses for initial access in accordance with examples as disclosed herein. The process flow 900 may implement or be implemented to realize aspects of the wireless communications system 100, the wireless communications system 200, the wireless communications system 201, the one-shot initial access procedure 300, the resource mappings 400, 500, and 600, the RIS configuration 700, or the process flow 800. In some implementations, a UE 115 and a base station 105 may participate in a one-shot initial access procedure involving an RIS 205 in accordance with the examples disclosed herein.

In the following description of the process flow 900, the operations may be performed (such as reported or provided) in a different order than the order shown, or the operations performed by the example devices may be performed in different orders or at different times. Some operations also may be omitted from the process flow 900, or other operations may be added to the process flow 900. Further, although some operations or signaling may be shown to occur at different times for discussion purposes, these operations may actually occur at the same time or otherwise concurrently.

At 905, the base station 105 may transmit, to the RIS 205 (or a device, such as an RIS CU 225, controlling the RIS 205), an indication to divide the RIS 205 into a set of portions of the RIS 205. Such portions of the RIS 205 may be understood as or equivalently referred to as sub-RISs 315 and each sub-RIS 315 may be associated with a different reflected beam 310 and a different frequency shift.

At 910, the RIS 205 (or a device, such as an RIS CU 225, controlling the RIS 205) may configure the set of sub-RISs 315 in accordance with the indication received at 905. In some implementations, the RIS 205 may configure the set of sub-RISs 315 for a reflecting of SSBs from the base station 105 to the UE 115 and for a reflecting of a random access preamble from the UE 115 to the base station 105.

At 915, the base station 105 may transmit one or more SSBs for each beam 305 of a set of beams 305. In some implementations, the base station 105 may transmit the SSBs as part of a one-shot initial access procedure 300 between the UE 115 and the base station 105 via the RIS 205. The UE 115 may, additionally or alternatively, directly receive an SSB from the base station 105 (e.g., without reflection off the RIS 205). The UE 115 may measure, for each beam 305 of the set of beams 305, an SSB over a set of occasions associated with the one-shot initial access procedure 300 and identify during which occasion the UE 115 measures an SSB having a greatest signal strength.

At 920, the UE 115 may transmit a random access preamble during a RACH occasion 405 based on during which occasion of the one-shot initial access procedure 300 the UE 115 measures an SSB having a greatest signal strength. The base station 105 may monitor a set of RACH occasions 405 for the random access preamble from the UE 115 based on each sub-RIS 315 being associated with a different frequency shift, where different RACH occasions may correspond to different frequency shifts of the set of sub-RISs 315. As such, based on during which RACH occasion 405 the base station 105 detects the random access preamble from the UE 115, the base station 105 may identify which sub-RIS 315 of the set of sub-RISs 315 reflected the random access preamble from the UE 115 to the base station 105. The base station 105 may likewise identify a configuration (e.g., a reflection characteristic or configuration) of the sub-RIS 315 which reflected the random access preamble.

At 925, the base station 105 may transmit, to the RIS 205 (or a device, such as an RIS CU 225, controlling the RIS 205), an indication of the reconfiguration for the RIS 205 for reflecting communications between the base station 105 and the UE 115. For example, the base station 105 may indicate a reconfiguration for the RIS 205 based on the configuration of the sub-RIS 315 which reflected the random access preamble from the UE 115 to the base station 105.

At 930, the RIS 205 (or a device, such as an RIS CU 225, controlling the RIS 205) may reconfigure the RIS 205 in accordance with the reconfiguration indicated at 925. As such, the RIS 205 may reflect communications between the base station 105 and the UE 115.

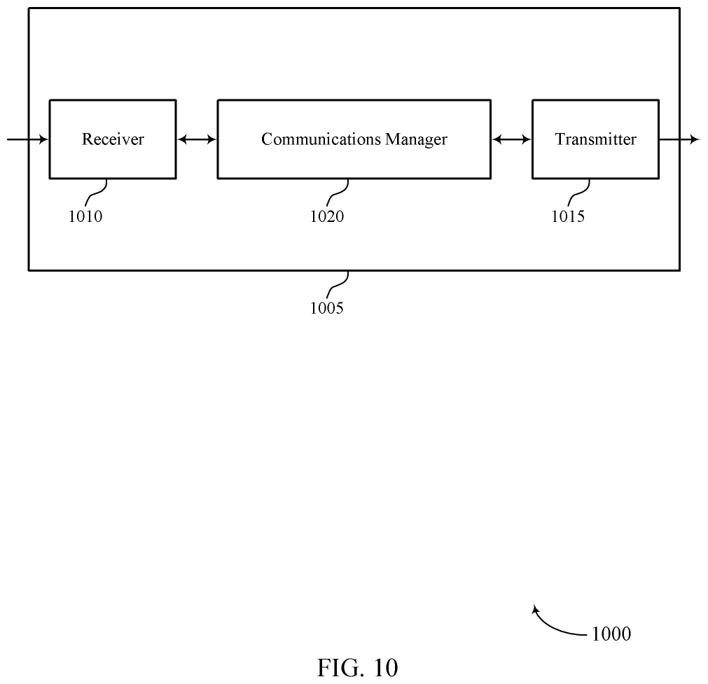

FIG. 10 shows a block diagram 1000 of a device 1005 that supports methods and apparatuses for initial access in accordance with examples as disclosed herein. The device 1005 may be an example of aspects of a UE 115 or a device including, coupled with, or otherwise capable of configuring or controlling an RIS 205 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to one-shot initial access). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to one-shot initial access). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of one-shot initial access as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 1020 may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communication at a UE in accordance with examples as disclosed herein. For example, the communications manager 1020 may be configured as or otherwise support a means for receiving, from a base station, a control message indicating a quantity of synchronization rasters for each beam of a set of multiple beams. The communications manager 1020 may be configured as or otherwise support a means for measuring, for each beam of the set of multiple beams, one or more SSBs over a quantity of monitoring occasions based on the quantity of synchronization rasters for each beam. The communications manager 1020 may be configured as or otherwise support a means for transmitting, to the base station, a random access preamble during a random access occasion based on the measuring.

Additionally or alternatively, the communications manager 1020 may support wireless communication at a device controlling a surface in accordance with examples as disclosed herein. For example, the communications manager 1020 may be configured as or otherwise support a means for receiving, from a base station, an indication to divide the surface into a set of portions of the surface, each portion of the set of portions associated with a different reflected beam and a different frequency shift. The communications manager 1020 may be configured as or otherwise support a means for configuring, for a reflecting of SSBs from the base station to a UE and for a reflecting of a random access preamble from the UE to the base station, the set of portions of the surface in accordance with the indication. The communications manager 1020 may be configured as or otherwise support a means for receiving, from the base station, a reconfiguration for the surface for reflecting communications between the base station and the UE based on the configuring of the set of portions of the surface.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for reduced processing, reduced power consumption, and more efficient utilization of communication resources.

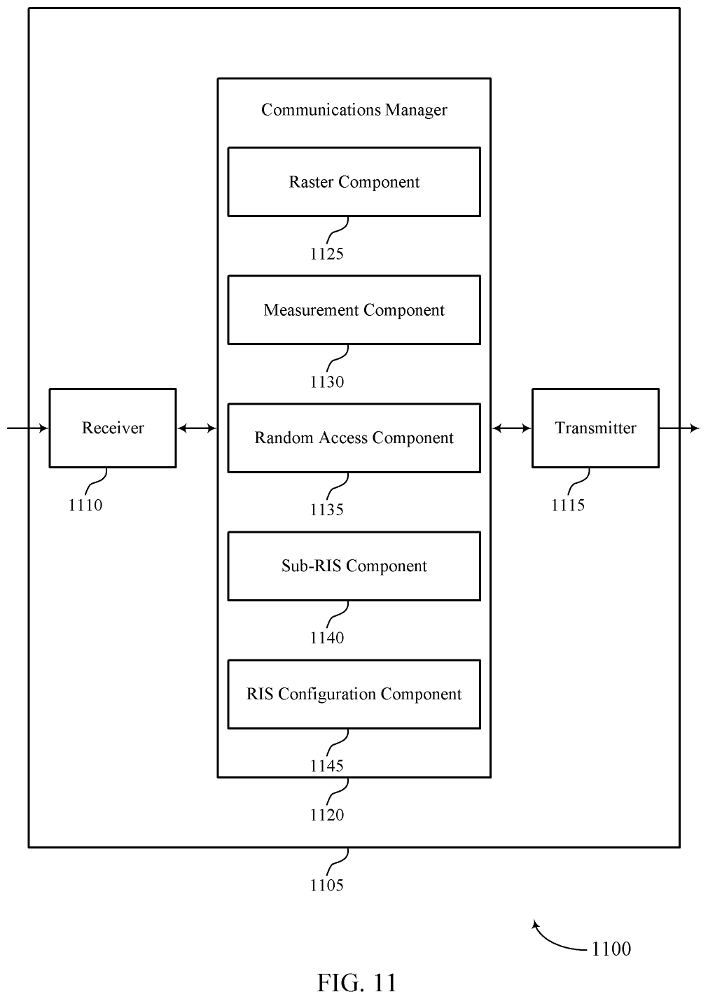

FIG. 11 shows a block diagram 1100 of a device 1105 that supports methods and apparatuses for initial access in accordance with examples as disclosed herein. The device 1105 may be an example of aspects of a device 1005 or a UE 115 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to one-shot initial access). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to one-shot initial access). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of one-shot initial access as described herein. For example, the communications manager 1120 may include a raster component 1125, a measurement component 1130, a random access component 1135, a sub-RIS component 1140, a RIS configuration component 1145, or any combination thereof. The communications manager 1120 may be an example of aspects of a communications manager 1020 as described herein. In some examples, the communications manager 1120, or various components thereof, may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communication at a UE in accordance with examples as disclosed herein. The raster component 1125 may be configured as or otherwise support a means for receiving, from a base station, a control message indicating a quantity of synchronization rasters for each beam of a set of multiple beams. The measurement component 1130 may be configured as or otherwise support a means for measuring, for each beam of the set of multiple beams, one or more SSBs over a quantity of monitoring occasions based on the quantity of synchronization rasters for each beam. The random access component 1135 may be configured as or otherwise support a means for transmitting, to the base station, a random access preamble during a random access occasion based on the measuring.

Additionally or alternatively, the communications manager 1120 may support wireless communication at a device controlling a surface in accordance with examples as disclosed herein. The sub-RIS component 1140 may be configured as or otherwise support a means for receiving, from a base station, an indication to divide the surface into a set of portions of the surface, each portion of the set of portions associated with a different reflected beam and a different frequency shift. The RIS configuration component 1145 may be configured as or otherwise support a means for configuring, for a reflecting of SSBs from the base station to a UE and for a reflecting of a random access preamble from the UE to the base station, the set of portions of the surface in accordance with the indication. The RIS configuration component 1145 may be configured as or otherwise support a means for receiving, from the base station, a reconfiguration for the surface for reflecting communications between the base station and the UE based on the configuring of the set of portions of the surface.

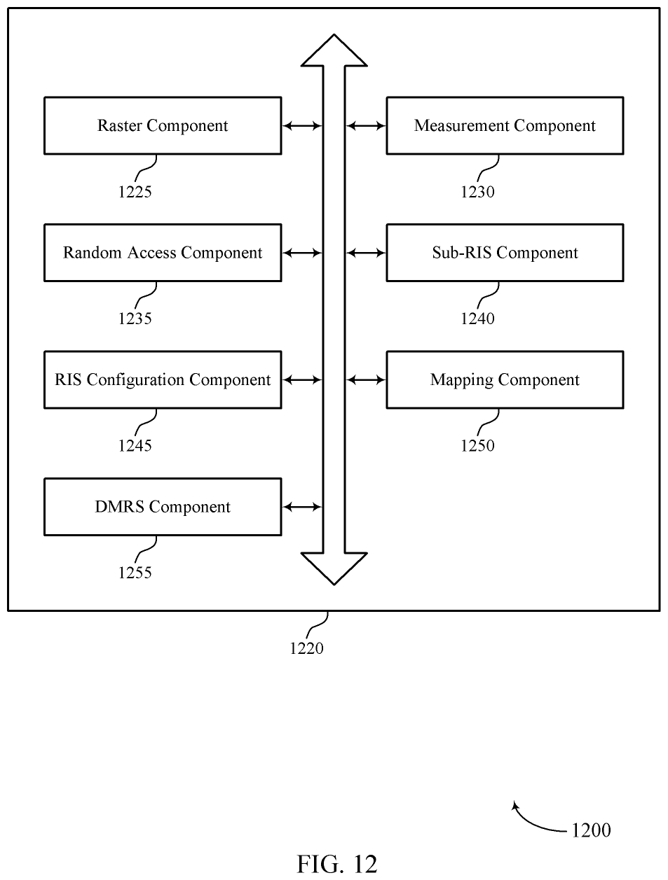

FIG. 12 shows a block diagram 1200 of a communications manager 1220 that supports methods and apparatuses for initial access in accordance with examples as disclosed herein. The communications manager 1220 may be an example of aspects of a communications manager 1020, a communications manager 1120, or both, as described herein. The communications manager 1220, or various components thereof, may be an example of means for performing various aspects of one-shot initial access as described herein. For example, the communications manager 1220 may include a raster component 1225, a measurement component 1230, a random access component 1235, a sub-RIS component 1240, a RIS configuration component 1245, a mapping component 1250, a DMRS component 1255, or any combination thereof. Each of these components may communicate, directly or indirectly, with one another (e.g., via one or more buses).

The communications manager 1220 may support wireless communication at a UE in accordance with examples as disclosed herein. The raster component 1225 may be configured as or otherwise support a means for receiving, from a base station, a control message indicating a quantity of synchronization rasters for each beam of a set of multiple beams. The measurement component 1230 may be configured as or otherwise support a means for measuring, for each beam of the set of multiple beams, one or more SSBs over a quantity of monitoring occasions based on the quantity of synchronization rasters for each beam. The random access component 1235 may be configured as or otherwise support a means for transmitting, to the base station, a random access preamble during a random access occasion based on the measuring.

In some examples, to support measuring, for each beam of the set of multiple beams, the one or more SSBs over the quantity of monitoring occasions, the measurement component 1230 may be configured as or otherwise support a means for measuring that a SSB associated with a synchronization raster of a beam of the set of multiple beams has a signal strength that satisfies a threshold signal strength, where transmitting the random access preamble during the random access occasion is based on the beam and the synchronization raster.

In some examples, different synchronization rasters correspond to different random access occasions, and the random access component 1235 may be configured as or otherwise support a means for calculating a value associated with the random access occasion based on the beam and the synchronization raster. In some examples, different synchronization rasters correspond to different random access occasions, and the random access component 1235 may be configured as or otherwise support a means for selecting the random access occasion based on the value.

In some examples, the random access component 1235 may be configured as or otherwise support a means for receiving an indication of a parameter associated with a separation in a frequency domain between the different random access occasions, where calculating the value associated with the random access occasion is further based on the parameter.

In some examples, multiple synchronization rasters of the beam correspond to the random access occasion, and the random access component 1235 may be configured as or otherwise support a means for receiving, from the base station, an indication of a set of random access preambles that are allocated to the multiple synchronization rasters, each synchronization raster of the multiple synchronization rasters being allocated a different subset of random access preambles of the set of random access preambles. In some examples, multiple synchronization rasters of the beam correspond to the random access occasion, and the random access component 1235 may be configured as or otherwise support a means for selecting the random access preamble from a subset of random access preambles that are allocated to the synchronization raster, where transmitting the random access preamble during the random access occasion is based on the selecting of the random access preamble.

In some examples, the multiple synchronization rasters of the beam correspond to the random access occasion, and the random access component 1235 may be configured as or otherwise support a means for receiving, from the base station, a random access response associated with the random access preamble. In some examples, the multiple synchronization rasters of the beam correspond to the random access occasion, and the raster component 1225 may be configured as or otherwise support a means for transmitting, to the base station and based on receiving the random access response, a random access message indicating the synchronization raster.

In some examples, the DMRS component 1255 may be configured as or otherwise support a means for generating a sequence for a demodulation reference signal of the random access message based on the synchronization raster. In some examples, the DMRS component 1255 may be configured as or otherwise support a means for transmitting, via the random access message, the demodulation reference signal using the sequence that is generated based on the synchronization raster.

In some examples, to support transmitting the random access message indicating the synchronization raster, the raster component 1225 may be configured as or otherwise support a means for transmitting an indication of the synchronization raster via a field of the random access message.

In some examples, the mapping component 1250 may be configured as or otherwise support a means for mapping the beam and the synchronization raster to an index. In some examples, the random access component 1235 may be configured as or otherwise support a means for calculating a value associated with the random access occasion based on the index. In some examples, the random access component 1235 may be configured as or otherwise support a means for selecting the random access occasion based on the value.

In some examples, different beam and synchronization raster pairs correspond to different indices in accordance with a mapping function.

In some examples, the random access component 1235 may be configured as or otherwise support a means for receiving, from the base station, an indication of a procedure according to which the UE selects one or both of the random access preamble and the random access occasion based on the quantity of synchronization rasters being associated with each beam of the set of multiple beams.

In some examples, the quantity of synchronization rasters is equal to a summation of a quantity of reflected beams from a surface and one synchronization raster associated with direct signaling from the base station without reflection from the surface, and one or both of the random access preamble and the random access occasion are associated with a reflected beam of the quantity of reflected beams.

In some examples, each beam and synchronization raster pair corresponds to a different monitoring occasion of a beam sweeping procedure between the base station and the UE and the quantity of monitoring occasions for each beam is equal to the quantity of synchronization rasters for each beam.

Additionally or alternatively, the communications manager 1220 may support wireless communication at a device controlling a surface in accordance with examples as disclosed herein. The sub-RIS component 1240 may be configured as or otherwise support a means for receiving, from a base station, an indication to divide the surface into a set of portions of the surface, each portion of the set of portions associated with a different reflected beam and a different frequency shift. The RIS configuration component 1245 may be configured as or otherwise support a means for configuring, for a reflecting of SSBs from the base station to a UE and for a reflecting of a random access preamble from the UE to the base station, the set of portions of the surface in accordance with the indication. In some examples, the RIS configuration component 1245 may be configured as or otherwise support a means for receiving, from the base station, a reconfiguration for the surface for reflecting communications between the base station and the UE based on the configuring of the set of portions of the surface.

In some examples, the RIS configuration component 1245 may be configured as or otherwise support a means for configuring, for the reflecting of the communications between the base station and the UE, the surface in accordance with the reconfiguration.

In some examples, the reconfiguration for the surface is based on a frequency shift of a portion of the surface, the portion of the surface associated with a successful reflection of the random access preamble from the UE to the base station. In some examples, the surface is an RIS including a set of reflective elements.

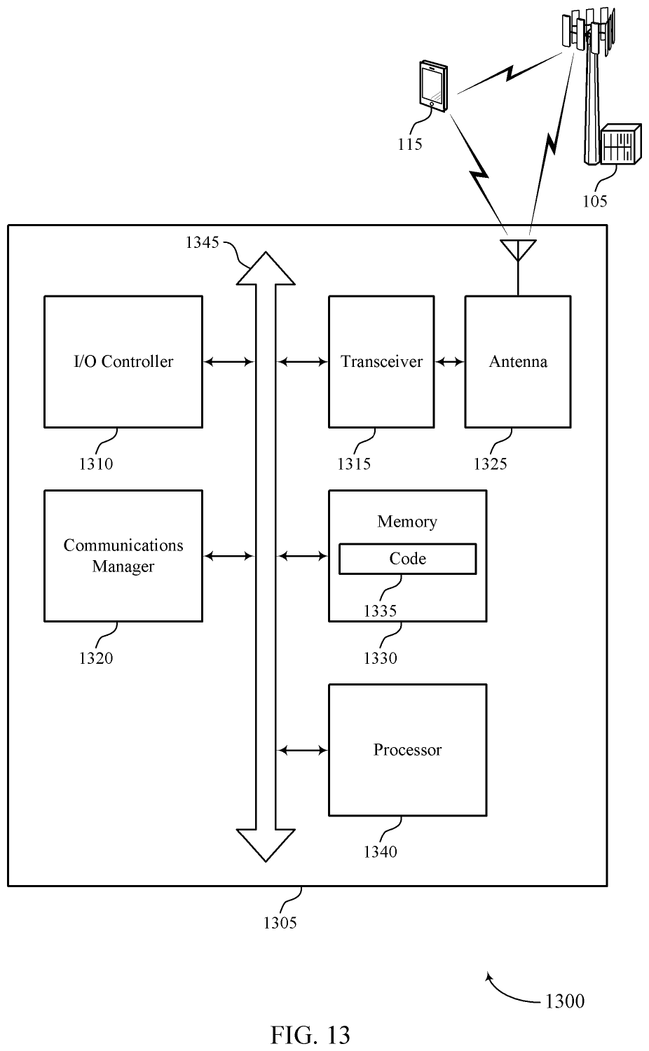

FIG. 13 shows a diagram of a system 1300 including a device 1305 that supports methods and apparatuses for initial access in accordance with examples as disclosed herein. The device 1305 may be an example of or include the components of a device 1005, a device 1105, or a UE 115 as described herein. The device 1305 may communicate wirelessly with one or more base stations 105, UEs 115, or any combination thereof. The device 1305 may include components for bi-directional voice and data communications including components for transmitting and receiving communications, such as a communications manager 1320, an input/output (I/O) controller 1310, a transceiver 1315, an antenna 1325, a memory 1330, code 1335, and a processor 1340. These components may be in electronic communication or otherwise coupled (e.g., operatively, communicatively, functionally, electronically, electrically) via one or more buses (e.g., a bus 1345).

The I/O controller 1310 may manage input and output signals for the device 1305. The I/O controller 1310 may also manage peripherals not integrated into the device 1305. In some cases, the I/O controller 1310 may represent a physical connection or port to an external peripheral. In some cases, the I/O controller 1310 may utilize an operating system such as iOS®, ANDROID®, MS-DOS®, MS-WINDOWS®, OS/2®, UNIX®, LINUX®, or another known operating system. Additionally or alternatively, the I/O controller 1310 may represent or interact with a modem, a keyboard, a mouse, a touchscreen, or a similar device. In some cases, the I/O controller 1310 may be implemented as part of a processor, such as the processor 1340. In some cases, a user may interact with the device 1305 via the I/O controller 1310 or via hardware components controlled by the I/O controller 1310.

In some cases, the device 1305 may include a single antenna 1325. However, in some other cases, the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The memory 1330 may include random access memory (RAM) and read-only memory (ROM). The memory 1330 may store computer-readable, computer-executable code 1335 including instructions that, when executed by the processor 1340, cause the device 1305 to perform various functions described herein. The code 1335 may be stored in a non-transitory computer-readable medium such as system memory or another type of memory. In some cases, the code 1335 may not be directly executable by the processor 1340 but may cause a computer (e.g., when compiled and executed) to perform functions described herein. In some cases, the memory 1330 may contain, among other things, a basic I/O system (BIOS) which may control basic hardware or software operation such as the interaction with peripheral components or devices.

The processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting one-shot initial access). For example, the device 1305 or a component of the device 1305 may include a processor 1340 and memory 1330 coupled with or to the processor 1340, the processor 1340 and memory 1330 configured to perform various functions described herein.

The communications manager 1320 may support wireless communication at a UE in accordance with examples as disclosed herein. For example, the communications manager 1320 may be configured as or otherwise support a means for receiving, from a base station, a control message indicating a quantity of synchronization rasters for each beam of a set of multiple beams. The communications manager 1320 may be configured as or otherwise support a means for measuring, for each beam of the set of multiple beams, one or more SSBs over a quantity of monitoring occasions based on the quantity of synchronization rasters for each beam. The communications manager 1320 may be configured as or otherwise support a means for transmitting, to the base station, a random access preamble during a random access occasion based on the measuring.

Additionally or alternatively, the communications manager 1320 may support wireless communication at a device controlling a surface in accordance with examples as disclosed herein. For example, the communications manager 1320 may be configured as or otherwise support a means for receiving, from a base station, an indication to divide the surface into a set of portions of the surface, each portion of the set of portions associated with a different reflected beam and a different frequency shift. The communications manager 1320 may be configured as or otherwise support a means for configuring, for a reflecting of SSBs from the base station to a UE and for a reflecting of a random access preamble from the UE to the base station, the set of portions of the surface in accordance with the indication. The communications manager 1320 may be configured as or otherwise support a means for receiving, from the base station, a reconfiguration for the surface for reflecting communications between the base station and the UE based on the configuring of the set of portions of the surface.

By including or configuring the communications manager 1320 in accordance with examples as described herein, the device 1305 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the processor 1340, the memory 1330, the code 1335, or any combination thereof. For example, the code 1335 may include instructions executable by the processor 1340 to cause the device 1305 to perform various aspects of one-shot initial access as described herein, or the processor 1340 and the memory 1330 may be otherwise configured to perform or support such operations.

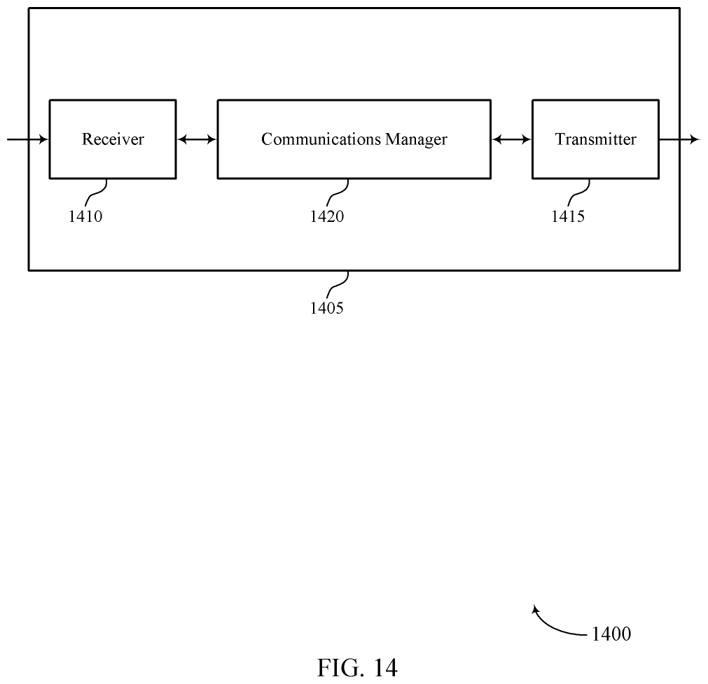

FIG. 14 shows a block diagram 1400 of a device 1405 that supports methods and apparatuses for initial access in accordance with examples as disclosed herein. The device 1405 may be an example of aspects of a base station 105 as described herein. The device 1405 may include a receiver 1410, a transmitter 1415, and a communications manager 1420. The device 1405 may also include a processor. Each of these components may be in communication with one another (e.g., via one or more buses).

The receiver 1410 may provide a means for receiving information such as packets, user data, control information, or any combination thereof associated with various information channels (e.g., control channels, data channels, information channels related to one-shot initial access). Information may be passed on to other components of the device 1405. The receiver 1410 may utilize a single antenna or a set of multiple antennas.

The transmitter 1415 may provide a means for transmitting signals generated by other components of the device 1405. For example, the transmitter 1415 may transmit information such as packets, user data, control information, or any combination thereof associated with various information channels (e.g., control channels, data channels, information channels related to one-shot initial access). In some examples, the transmitter 1415 may be co-located with a receiver 1410 in a transceiver module. The transmitter 1415 may utilize a single antenna or a set of multiple antennas.

The communications manager 1420, the receiver 1410, the transmitter 1415, or various combinations thereof or various components thereof may be examples of means for performing various aspects of one-shot initial access as described herein. For example, the communications manager 1420, the receiver 1410, the transmitter 1415, or various combinations or components thereof may support a method for performing one or more of the functions described herein.

In some examples, the communications manager 1420, the receiver 1410, the transmitter 1415, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1420, the receiver 1410, the transmitter 1415, or various combinations or components thereof may be implemented in code (e.g., as communications management software or firmware) executed by a processor. If implemented in code executed by a processor, the functions of the communications manager 1420, the receiver 1410, the transmitter 1415, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1420 may be configured to perform various operations (e.g., receiving, monitoring, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to receive information, transmit information, or perform various other operations as described herein.

The communications manager 1420 may support wireless communication at a base station in accordance with examples as disclosed herein. For example, the communications manager 1420 may be configured as or otherwise support a means for transmitting, to a UE, a control message indicating a quantity of synchronization rasters for each beam of a set of multiple beams. The communications manager 1420 may be configured as or otherwise support a means for transmitting, for each beam of the set of multiple beams, one or more SSBs. The communications manager 1420 may be configured as or otherwise support a means for receiving, from the UE, a random access preamble during a random access occasion based on the transmitting.

Additionally or alternatively, the communications manager 1420 may support wireless communication at a base station in accordance with examples as disclosed herein. For example, the communications manager 1420 may be configured as or otherwise support a means for transmitting, to a device controlling a surface, an indication to divide the surface into a set of portions of the surface, each portion of the set of portions associated with a different reflected beam and a different frequency shift. The communications manager 1420 may be configured as or otherwise support a means for transmitting, to a UE via the surface, one or more SSBs for each beam of a set of multiple beams. The communications manager 1420 may be configured as or otherwise support a means for receiving, from the UE, a random access preamble during a random access occasion based on the transmitting of the one or more SSBs for each beam of the set of multiple beams. The communications manager 1420 may be configured as or otherwise support a means for transmitting, to the device controlling the surface, an indication of a reconfiguration for the surface for reflecting communications between the base station and the UE based on the receiving of the random access preamble during the random access occasion.

By including or configuring the communications manager 1420 in accordance with examples as described herein, the device 1405 (e.g., a processor controlling or otherwise coupled with the receiver 1410, the transmitter 1415, the communications manager 1420, or a combination thereof) may support techniques for reduced processing, reduced power consumption, and more efficient utilization of communication resources.

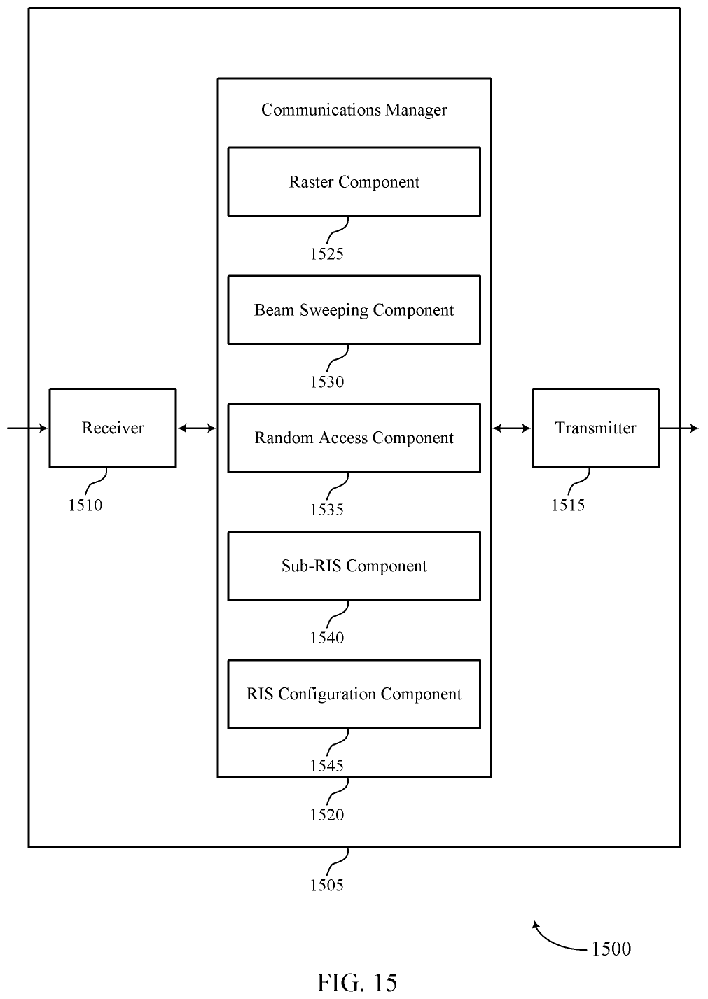

FIG. 15 shows a block diagram 1500 of a device 1505 that supports methods and apparatuses for initial access in accordance with examples as disclosed herein. The device 1505 may be an example of aspects of a device 1405 or a base station 105 as described herein. The device 1505 may include a receiver 1510, a transmitter 1515, and a communications manager 1520. The device 1505 may also include a processor. Each of these components may be in communication with one another (e.g., via one or more buses).

The receiver 1510 may provide a means for receiving information such as packets, user data, control information, or any combination thereof associated with various information channels (e.g., control channels, data channels, information channels related to one-shot initial access). Information may be passed on to other components of the device 1505. The receiver 1510 may utilize a single antenna or a set of multiple antennas.

The transmitter 1515 may provide a means for transmitting signals generated by other components of the device 1505. For example, the transmitter 1515 may transmit information such as packets, user data, control information, or any combination thereof associated with various information channels (e.g., control channels, data channels, information channels related to one-shot initial access). In some examples, the transmitter 1515 may be co-located with a receiver 1510 in a transceiver module. The transmitter 1515 may utilize a single antenna or a set of multiple antennas.

The device 1505, or various components thereof, may be an example of means for performing various aspects of one-shot initial access as described herein. For example, the communications manager 1520 may include a raster component 1525, a beam sweeping component 1530, a random access component 1535, a sub-RIS component 1540, a RIS configuration component 1545, or any combination thereof. The communications manager 1520 may be an example of aspects of a communications manager 1420 as described herein. In some examples, the communications manager 1520, or various components thereof, may be configured to perform various operations (e.g., receiving, monitoring, transmitting) using or otherwise in cooperation with the receiver 1510, the transmitter 1515, or both. For example, the communications manager 1520 may receive information from the receiver 1510, send information to the transmitter 1515, or be integrated in combination with the receiver 1510, the transmitter 1515, or both to receive information, transmit information, or perform various other operations as described herein.

The communications manager 1520 may support wireless communication at a base station in accordance with examples as disclosed herein. The raster component 1525 may be configured as or otherwise support a means for transmitting, to a UE, a control message indicating a quantity of synchronization rasters for each beam of a set of multiple beams. The beam sweeping component 1530 may be configured as or otherwise support a means for transmitting, for each beam of the set of multiple beams, one or more SSBs. The random access component 1535 may be configured as or otherwise support a means for receiving, from the UE, a random access preamble during a random access occasion based on the transmitting.

Additionally or alternatively, the communications manager 1520 may support wireless communication at a base station in accordance with examples as disclosed herein. The sub-RIS component 1540 may be configured as or otherwise support a means for transmitting, to a device controlling a surface, an indication to divide the surface into a set of portions of the surface, each portion of the set of portions associated with a different reflected beam and a different frequency shift. The beam sweeping component 1530 may be configured as or otherwise support a means for transmitting, to a UE via the surface, one or more SSBs for each beam of a set of multiple beams. The random access component 1535 may be configured as or otherwise support a means for receiving, from the UE, a random access preamble during a random access occasion based on the transmitting of the one or more SSBs for each beam of the set of multiple beams. The RIS configuration component 1545 may be configured as or otherwise support a means for transmitting, to the device controlling the surface, an indication of a reconfiguration for the surface for reflecting communications between the base station and the UE based on the receiving of the random access preamble during the random access occasion.

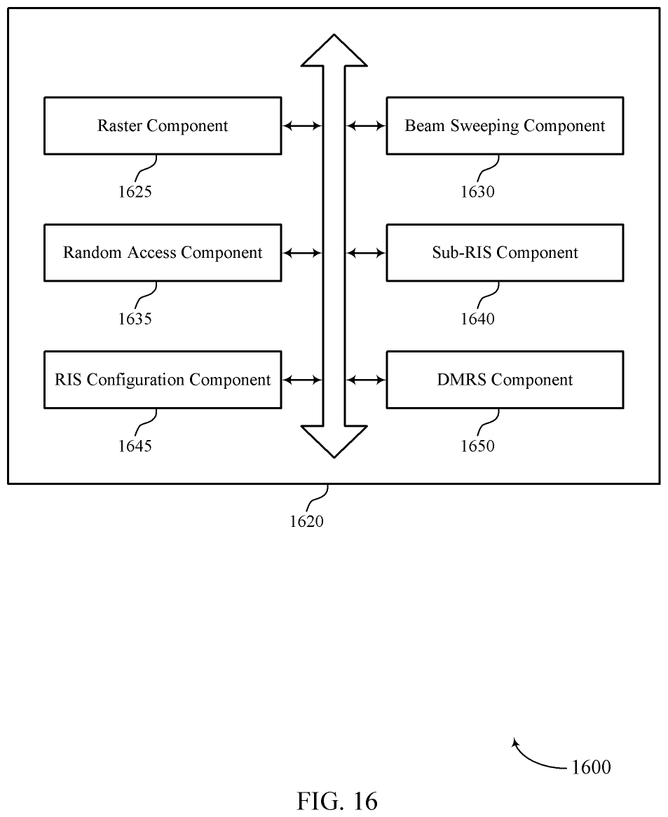

FIG. 16 shows a block diagram 1600 of a communications manager 1620 that supports methods and apparatuses for initial access in accordance with examples as disclosed herein. The communications manager 1620 may be an example of aspects of a communications manager 1420, a communications manager 1520, or both, as described herein. The communications manager 1620, or various components thereof, may be an example of means for performing various aspects of one-shot initial access as described herein. For example, the communications manager 1620 may include a raster component 1625, a beam sweeping component 1630, a random access component 1635, a sub-RIS component 1640, a RIS configuration component 1645, a DMRS component 1650, or any combination thereof. Each of these components may communicate, directly or indirectly, with one another (e.g., via one or more buses).

The communications manager 1620 may support wireless communication at a base station in accordance with examples as disclosed herein. The raster component 1625 may be configured as or otherwise support a means for transmitting, to a UE, a control message indicating a quantity of synchronization rasters for each beam of a set of multiple beams. The beam sweeping component 1630 may be configured as or otherwise support a means for transmitting, for each beam of the set of multiple beams, one or more SSBs. The random access component 1635 may be configured as or otherwise support a means for receiving, from the UE, a random access preamble during a random access occasion based on the transmitting.

In some examples, the random access component 1635 may be configured as or otherwise support a means for monitoring a set of multiple random access occasions based on the quantity of synchronization rasters for each beam of the set of multiple beams, where receiving the random access preamble during the random access occasion is based on the monitoring of the set of multiple random access occasions.

In some examples, the random access preamble and the random access occasion are associated with a synchronization raster of a beam of the set of multiple beams associated with a signal strength that satisfies a threshold signal strength.

In some examples, different synchronization rasters correspond to different random access occasions, and the random access component 1635 may be configured as or otherwise support a means for transmitting, to the UE, an indication of a parameter associated with a separation in a frequency domain between the different random access occasions, the parameter for a calculation, at the UE, of a value associated with the random access occasion, where receiving the random access preamble during the random access occasion is based on the beam, the synchronization raster, and the parameter.

In some examples, multiple synchronization rasters of the beam correspond to the random access occasion, and the random access component 1635 may be configured as or otherwise support a means for transmitting, to the UE, an indication of a set of random access preambles that are allocated to the multiple synchronization rasters, each synchronization raster of the multiple synchronization rasters being allocated a different subset of random access preambles of the set of random access preambles, where receiving the random access preamble is based on the transmitting of the indication of the set of random access preambles that are allocated to the multiple synchronization rasters and the synchronization raster.

In some examples, multiple synchronization rasters of the beam correspond to the random access occasion, and the random access component 1635 may be configured as or otherwise support a means for transmitting, to the UE, a random access response associated with the random access preamble. In some examples, multiple synchronization rasters of the beam correspond to the random access occasion, and the raster component 1625 may be configured as or otherwise support a means for receiving, from the UE and based on transmitting the random access response, a random access message indicating the synchronization raster.

In some examples, to support receiving the random access message indicating the synchronization raster, the DMRS component 1650 may be configured as or otherwise support a means for receiving, via the random access message, a demodulation reference signal associated with a sequence that is based on the synchronization raster.

In some examples, to support receiving the random access message indicating the synchronization raster, the raster component 1625 may be configured as or otherwise support a means for receiving an indication of the synchronization raster via a field of the random access message.

In some examples, the random access component 1635 may be configured as or otherwise support a means for transmitting, to the UE, an indication of a procedure according to which the UE selects one or both of the random access preamble and the random access occasion based on the quantity of synchronization rasters being associated with each beam of the set of multiple beams.

In some examples, the RIS configuration component 1645 may be configured as or otherwise support a means for transmitting, to a device controlling a surface, an indication of a configuration of the surface for reflecting communications between the base station and the UE based on one or both of the random access preamble and the random access occasion.

In some examples, the quantity of synchronization rasters is equal to a summation of a quantity of reflected beams from a surface and one synchronization raster associated with direct signaling from the base station without reflection from the surface, and one or both of the random access preamble and the random access occasion are associated with a reflected beam of the quantity of reflected beams.

In some examples, each beam and synchronization raster pair corresponds to a different monitoring occasion of a beam sweeping procedure between the base station and the UE and the quantity of monitoring occasions for each beam is equal to the quantity of synchronization rasters for each beam.

Additionally or alternatively, the communications manager 1620 may support wireless communication at a base station in accordance with examples as disclosed herein. The sub-RIS component 1640 may be configured as or otherwise support a means for transmitting, to a device controlling a surface, an indication to divide the surface into a set of portions of the surface, each portion of the set of portions associated with a different reflected beam and a different frequency shift. In some examples, the beam sweeping component 1630 may be configured as or otherwise support a means for transmitting, to a UE via the surface, one or more SSBs for each beam of a set of multiple beams. In some examples, the random access component 1635 may be configured as or otherwise support a means for receiving, from the UE, a random access preamble during a random access occasion based on the transmitting of the one or more SSBs for each beam of the set of multiple beams. The RIS configuration component 1645 may be configured as or otherwise support a means for transmitting, to the device controlling the surface, an indication of a reconfiguration for the surface for reflecting communications between the base station and the UE based on the receiving of the random access preamble during the random access occasion.

In some examples, the random access component 1635 may be configured as or otherwise support a means for monitoring a set of multiple random access occasions based on each portion of the surface being associated with a different frequency shift, where different random access occasions of the set of multiple random access occasions correspond to different frequency shifts of the set of portions of the surface.

In some examples, the configuration of the surface corresponds to the random access occasion in accordance with a mapping. In some examples, the surface is an RIS including a set of reflective elements.

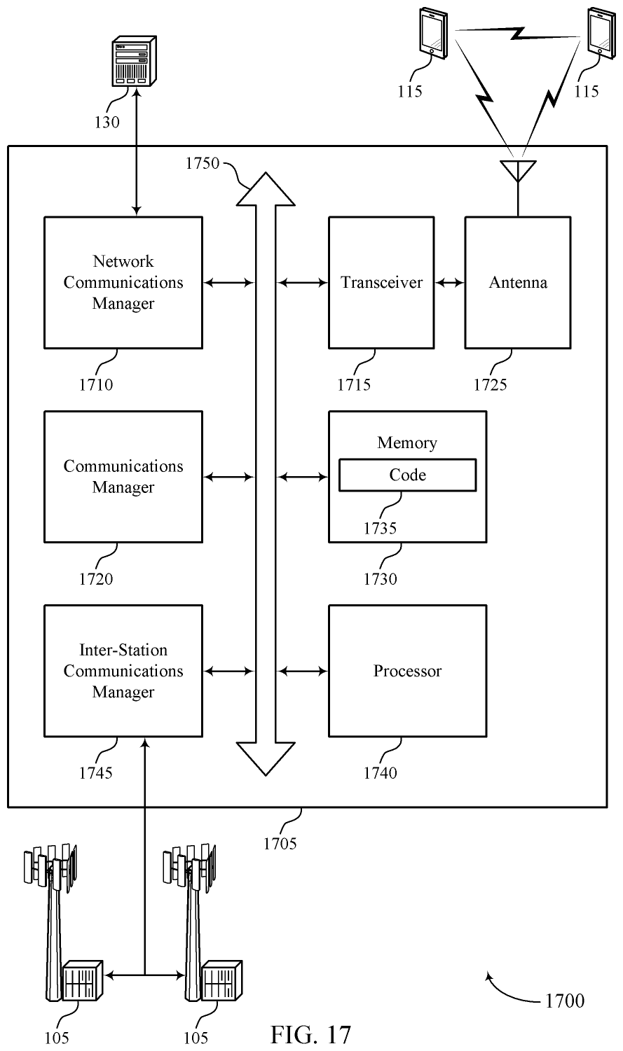

FIG. 17 shows a diagram of a system 1700 including a device 1705 that supports methods and apparatuses for initial access in accordance with examples as disclosed herein. The device 1705 may be an example of or include the components of a device 1405, a device 1505, or a base station 105 as described herein. The device 1705 may communicate wirelessly with one or more base stations 105, UEs 115, or any combination thereof. The device 1705 may include components for bi-directional voice and data communications including components for transmitting and receiving communications, such as a communications manager 1720, a network communications manager 1710, a transceiver 1715, an antenna 1725, a memory 1730, code 1735, a processor 1740, and an inter-station communications manager 1745. These components may be in electronic communication or otherwise coupled (e.g., operatively, communicatively, functionally, electronically, electrically) via one or more buses (e.g., a bus 1750).

The network communications manager 1710 may manage communications with a core network 130 (e.g., via one or more wired backhaul links). For example, the network communications manager 1710 may manage the transfer of data communications for client devices, such as one or more UEs 115.

In some cases, the device 1705 may include a single antenna 1725. However, in some other cases the device 1705 may have more than one antenna 1725, which may be capable of concurrently transmitting or receiving multiple wireless transmissions. The transceiver 1715 may communicate bi-directionally, via the one or more antennas 1725, wired, or wireless links as described herein. For example, the transceiver 1715 may represent a wireless transceiver and may communicate bi-directionally with another wireless transceiver. The transceiver 1715 may also include a modem to modulate the packets, to provide the modulated packets to one or more antennas 1725 for transmission, and to demodulate packets received from the one or more antennas 1725. The transceiver 1715, or the transceiver 1715 and one or more antennas 1725, may be an example of a transmitter 1415, a transmitter 1515, a receiver 1410, a receiver 1510, or any combination thereof or component thereof, as described herein.

The memory 1730 may include RAM and ROM. The memory 1730 may store computer-readable, computer-executable code 1735 including instructions that, when executed by the processor 1740, cause the device 1705 to perform various functions described herein. The code 1735 may be stored in a non-transitory computer-readable medium such as system memory or another type of memory. In some cases, the code 1735 may not be directly executable by the processor 1740 but may cause a computer (e.g., when compiled and executed) to perform functions described herein. In some cases, the memory 1730 may contain, among other things, a BIOS which may control basic hardware or software operation such as the interaction with peripheral components or devices.

The processor 1740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1740 may be configured to operate a memory array using a memory controller. In some other cases, a memory controller may be integrated into the processor 1740. The processor 1740 may be configured to execute computer-readable instructions stored in a memory (e.g., the memory 1730) to cause the device 1705 to perform various functions (e.g., functions or tasks supporting one-shot initial access). For example, the device 1705 or a component of the device 1705 may include a processor 1740 and memory 1730 coupled with or to the processor 1740, the processor 1740 and memory 1730 configured to perform various functions described herein.

The inter-station communications manager 1745 may manage communications with other base stations 105 and may include a controller or scheduler for controlling communications with UEs 115 in cooperation with other base stations 105. For example, the inter-station communications manager 1745 may coordinate scheduling for transmissions to UEs 115 for various interference mitigation techniques such as beamforming or joint transmission. In some examples, the inter-station communications manager 1745 may provide an X2 interface within an LTE/LTE-A wireless communications network technology to provide communication between base stations 105.

The communications manager 1720 may support wireless communication at a base station in accordance with examples as disclosed herein. For example, the communications manager 1720 may be configured as or otherwise support a means for transmitting, to a UE, a control message indicating a quantity of synchronization rasters for each beam of a set of multiple beams. The communications manager 1720 may be configured as or otherwise support a means for transmitting, for each beam of the set of multiple beams, one or more SSBs. The communications manager 1720 may be configured as or otherwise support a means for receiving, from the UE, a random access preamble during a random access occasion based on the transmitting.

Additionally or alternatively, the communications manager 1720 may support wireless communication at a base station in accordance with examples as disclosed herein. For example, the communications manager 1720 may be configured as or otherwise support a means for transmitting, to a device controlling a surface, an indication to divide the surface into a set of portions of the surface, each portion of the set of portions associated with a different reflected beam and a different frequency shift. The communications manager 1720 may be configured as or otherwise support a means for transmitting, to a UE via the surface, one or more SSBs for each beam of a set of multiple beams. The communications manager 1720 may be configured as or otherwise support a means for receiving, from the UE, a random access preamble during a random access occasion based on the transmitting of the one or more SSBs for each beam of the set of multiple beams. The communications manager 1720 may be configured as or otherwise support a means for transmitting, to the device controlling the surface, an indication of a reconfiguration for the surface for reflecting communications between the base station and the UE based on the receiving of the random access preamble during the random access occasion.

By including or configuring the communications manager 1720 in accordance with examples as described herein, the device 1705 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 1720 may be configured to perform various operations (e.g., receiving, monitoring, transmitting) using or otherwise in cooperation with the transceiver 1715, the one or more antennas 1725, or any combination thereof. Although the communications manager 1720 is illustrated as a separate component, in some examples, one or more functions described with reference to the communications manager 1720 may be supported by or performed by the processor 1740, the memory 1730, the code 1735, or any combination thereof. For example, the code 1735 may include instructions executable by the processor 1740 to cause the device 1705 to perform various aspects of one-shot initial access as described herein, or the processor 1740 and the memory 1730 may be otherwise configured to perform or support such operations.

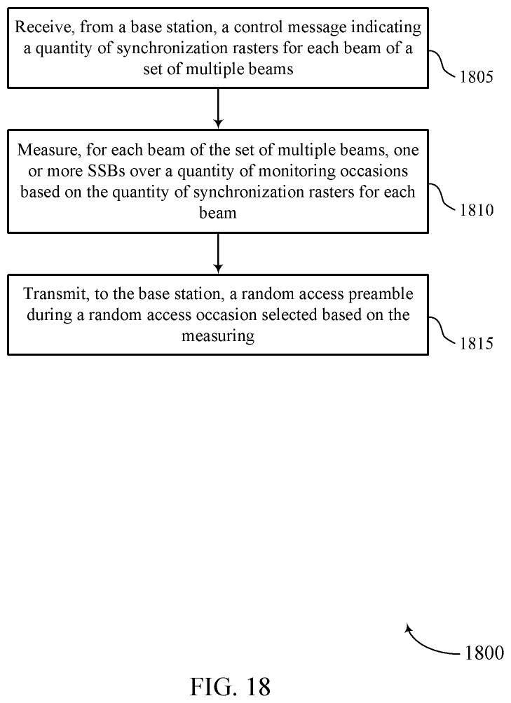

FIG. 18 shows a flowchart illustrating a method 1800 that supports methods and apparatuses for initial access in accordance with examples as disclosed herein. The operations of the method 1800 may be implemented by a UE or its components as described herein. For example, the operations of the method 1800 may be performed by a UE 115 as described with reference to FIGS. 1 through 13. In some examples, a UE may execute a set of instructions to control the functional elements of the UE to perform the described functions. Additionally or alternatively, the UE may perform aspects of the described functions using special-purpose hardware.

At 1805, the method may include receiving, from a base station, a control message indicating a quantity of synchronization rasters for each beam of a set of multiple beams. The operations of 1805 may be performed in accordance with examples as disclosed herein. In some examples, aspects of the operations of 1805 may be performed by a raster component 1225 as described with reference to FIG. 12.

At 1810, the method may include measuring, for each beam of the set of multiple beams, one or more SSBs over a quantity of monitoring occasions based on the quantity of synchronization rasters for each beam. The operations of 1810 may be performed in accordance with examples as disclosed herein. In some examples, aspects of the operations of 1810 may be performed by a measurement component 1230 as described with reference to FIG. 12.

At 1815, the method may include transmitting, to the base station, a random access preamble during a random access occasion selected based on the measuring. The operations of 1815 may be performed in accordance with examples as disclosed herein. In some examples, aspects of the operations of 1815 may be performed by a random access component 1235 as described with reference to FIG. 12.

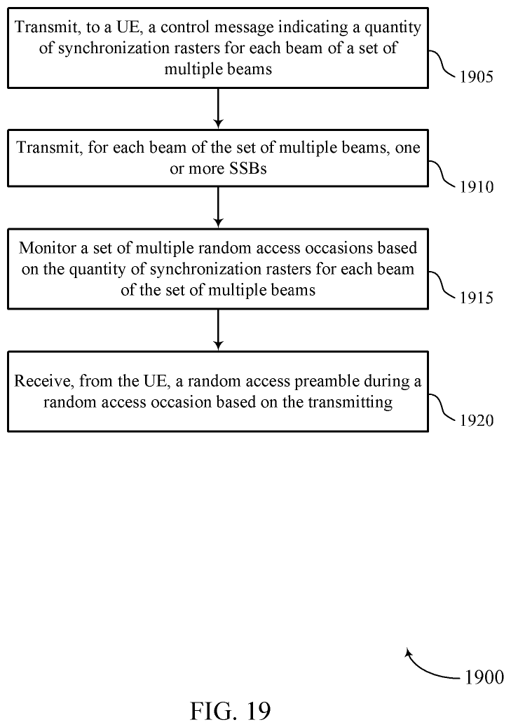

FIG. 19 shows a flowchart illustrating a method 1900 that supports methods and apparatuses for initial access in accordance with examples as disclosed herein. The operations of the method 1900 may be implemented by a base station or its components as described herein. For example, the operations of the method 1900 may be performed by a base station 105 as described with reference to FIGS. 1 through 9 and 14 through 17. In some examples, a base station may execute a set of instructions to control the functional elements of the base station to perform the described functions. Additionally or alternatively, the base station may perform aspects of the described functions using special-purpose hardware.

At 1905, the method may include transmitting, to a UE, a control message indicating a quantity of synchronization rasters for each beam of a set of multiple beams. The operations of 1905 may be performed in accordance with examples as disclosed herein. In some examples, aspects of the operations of 1905 may be performed by a raster component 1625 as described with reference to FIG. 16.

At 1910, the method may include transmitting, for each beam of the set of multiple beams, one or more SSBs. The operations of 1910 may be performed in accordance with examples as disclosed herein. In some examples, aspects of the operations of 1910 may be performed by a beam sweeping component 1630 as described with reference to FIG. 16.

At 1915, the method may include monitoring a set of multiple random access occasions based on the quantity of synchronization rasters for each beam of the set of multiple beams. The operations of 1915 may be performed in accordance with examples as disclosed herein. In some examples, aspects of the operations of 1915 may be performed by a random access component 1635 as described with reference to FIG. 16.

At 1920, the method may include receiving, from the UE, a random access preamble during a random access occasion based on the transmitting. The operations of 1920 may be performed in accordance with examples as disclosed herein. In some examples, aspects of the operations of 1920 may be performed by a random access component 1635 as described with reference to FIG. 16.

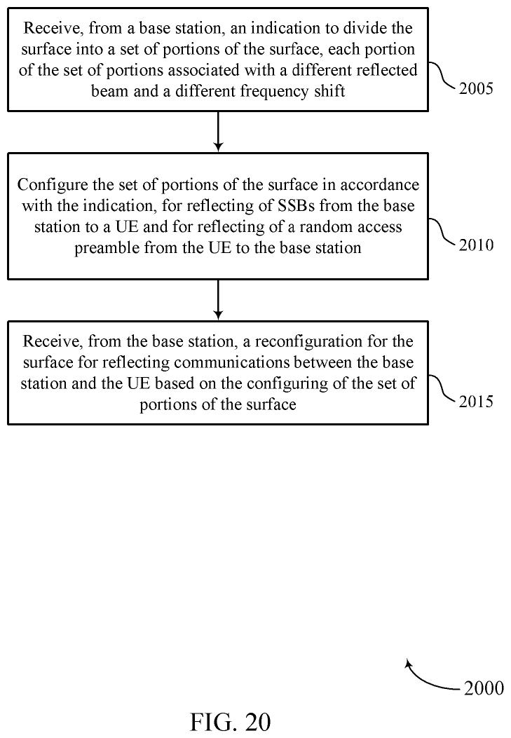

FIG. 20 shows a flowchart illustrating a method 2000 that supports methods and apparatuses for initial access in accordance with examples as disclosed herein. The operations of the method 2000 may be implemented by a device controlling a surface or its components as described herein. For example, the operations of the method 2000 may be performed by a RIS as described with reference to FIGS. 1 through 13. In some examples, a RIS may execute a set of instructions to control the functional elements of the RIS to perform the described functions. Additionally or alternatively, the RIS may perform aspects of the described functions using special-purpose hardware.

At 2005, the method may include receiving, from a base station, an indication to divide the surface into a set of portions of the surface, each portion of the set of portions associated with a different reflected beam and a different frequency shift. The operations of 2005 may be performed in accordance with examples as disclosed herein. In some examples, aspects of the operations of 2005 may be performed by a sub-RIS component 1240 as described with reference to FIG. 12.

At 2010, the method may include configuring the set of portions of the surface in accordance with the indication, for reflecting of SSBs from the base station to a UE and for reflecting of a random access preamble from the UE to the base station. The operations of 2010 may be performed in accordance with examples as disclosed herein. In some examples, aspects of the operations of 2010 may be performed by a RIS configuration component 1245 as described with reference to FIG. 12.

At 2015, the method may include receiving, from the base station, a reconfiguration for the surface for reflecting communications between the base station and the UE based on the configuring of the set of portions of the surface. The operations of 2015 may be performed in accordance with examples as disclosed herein. In some examples, aspects of the operations of 2015 may be performed by a RIS configuration component 1245 as described with reference to FIG. 12.

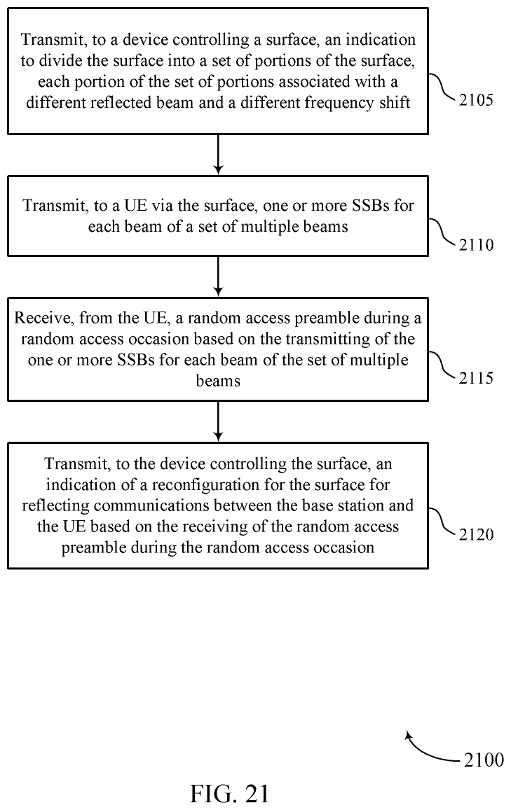

FIG. 21 shows a flowchart illustrating a method 2100 that supports methods and apparatuses for initial access in accordance with examples as disclosed herein. The operations of the method 2100 may be implemented by a base station or its components as described herein. For example, the operations of the method 2100 may be performed by a base station 105 as described with reference to FIGS. 1 through 9 and 14 through 17. In some examples, a base station may execute a set of instructions to control the functional elements of the base station to perform the described functions. Additionally or alternatively, the base station may perform aspects of the described functions using special-purpose hardware.

At 2105, the method may include transmitting, to a device controlling a surface, an indication to divide the surface into a set of portions of the surface, each portion of the set of portions associated with a different reflected beam and a different frequency shift. The operations of 2105 may be performed in accordance with examples as disclosed herein. In some examples, aspects of the operations of 2105 may be performed by a sub-RIS component 1640 as described with reference to FIG. 16.

At 2110, the method may include transmitting, to a UE via the surface, one or more SSBs for each beam of a set of multiple beams. The operations of 2110 may be performed in accordance with examples as disclosed herein. In some examples, aspects of the operations of 2110 may be performed by a beam sweeping component 1630 as described with reference to FIG. 16.

At 2115, the method may include receiving, from the UE, a random access preamble during a random access occasion based on the transmitting of the one or more SSBs for each beam of the set of multiple beams. The operations of 2115 may be performed in accordance with examples as disclosed herein. In some examples, aspects of the operations of 2115 may be performed by a random access component 1635 as described with reference to FIG. 16.

At 2120, the method may include transmitting, to the device controlling the surface, an indication of a reconfiguration for the surface for reflecting communications between the base station and the UE based on the receiving of the random access preamble during the random access occasion. The operations of 2120 may be performed in accordance with examples as disclosed herein. In some examples, aspects of the operations of 2120 may be performed by a RIS configuration component 1645 as described with reference to FIG. 16.

The following provides an overview of aspects of the present disclosure:

Aspect 1: A method for wireless communication at a UE, comprising: receiving, from a base station, a control message indicating a quantity of synchronization rasters for each beam of a plurality of beams; measuring, for each beam of the plurality of beams, one or more SSBs over a quantity of monitoring occasions based at least in part on the quantity of synchronization rasters for each beam; and transmitting, to the base station, a random access preamble during a random access occasion selected based at least in part on the measuring.

Aspect 2: The method of aspect 1, wherein measuring, for each beam of the plurality of beams, the one or more SSBs over the quantity of monitoring occasions comprises: determining that a SSB associated with a synchronization raster of a beam of the plurality of beams has a signal strength that satisfies a threshold signal strength, wherein transmitting the random access preamble during the random access occasion is based at least in part on the beam and the synchronization raster.

Aspect 3: The method of aspect 2, wherein different synchronization rasters correspond to different random access occasions, the method further comprising: calculating a frequency location associated with the random access occasion based at least in part on the beam and the synchronization raster; and selecting the random access occasion based at least in part on the frequency location.

Aspect 4: The method of aspect 3, further comprising: receiving an indication of a parameter associated with a separation in a frequency domain between the different random access occasions, wherein calculating the frequency location associated with the random access occasion is further based at least in part on the parameter.

Aspect 5: The method of aspect 2, wherein multiple synchronization rasters of the beam correspond to the random access occasion, the method further comprising: receiving, from the base station, an indication of a set of random access preambles that are allocated to the multiple synchronization rasters, each synchronization raster of the multiple synchronization rasters being allocated a different subset of random access preambles of the set of random access preambles; and selecting the random access preamble from a subset of random access preambles that are allocated to the synchronization raster, wherein transmitting the random access preamble during the random access occasion is based at least in part on the selecting of the random access preamble.

Aspect 6: The method of aspect 2, wherein multiple synchronization rasters of the beam correspond to the random access occasion, the method further comprising: receiving, from the base station, a random access response associated with the random access preamble; and transmitting, to the base station and based at least in part on receiving the random access response, a random access message indicating the synchronization raster.

Aspect 7: The method of aspect 6, further comprising: generating a sequence for a demodulation reference signal of the random access message based at least in part on the synchronization raster, wherein transmitting the random access message indicating the synchronization raster comprises: transmitting, via the random access message, the demodulation reference signal using the sequence that is generated based at least in part on the synchronization raster.

Aspect 8: The method of any of aspects 6 or 7, wherein transmitting the random access message indicating the synchronization raster comprises: transmitting an indication of the synchronization raster via a field of the random access message.

Aspect 9: The method of aspect 2, further comprising: mapping the beam and the synchronization raster to an index; calculating a frequency location associated with the random access occasion based at least in part on the index; and selecting the random access occasion based at least in part on the frequency location.

Aspect 10: The method of aspect 9, wherein different beam and synchronization raster pairs correspond to different indices in accordance with a mapping function.

Aspect 11: The method of any of aspects 1 through 10, further comprising: receiving, from the base station, an indication of a procedure according to which the UE selects one or both of the random access preamble and the random access occasion based at least in part on the quantity of synchronization rasters being associated with each beam of the plurality of beams.

Aspect 12: The method of aspect 11, wherein the procedure is associated with different synchronization rasters corresponding to different random access occasions, or multiple synchronization rasters of a same beam corresponding to a same random access occasion, or use of an index mapped to a beam and a synchronization raster to calculate a frequency location associated with the random access occasion, or a configuration of a surface for reflecting SSBs from the base station to the UE and for reflecting the random access preamble from the UE to the base station.

Aspect 13: The method of any of aspects 1 through 12, wherein the quantity of synchronization rasters is equal to a summation of a quantity of reflected beams from a surface and one synchronization raster associated with direct signaling from the base station without reflection from the surface, and one or both of the random access preamble and the random access occasion are associated with a reflected beam of the quantity of reflected beams.

Aspect 14: The method of any of aspects 1 through 13, wherein each beam and synchronization raster pair corresponds to a different monitoring occasion of a beam sweeping procedure between the base station and the UE and the quantity of monitoring occasions for each beam is equal to the quantity of synchronization rasters for each beam.

Aspect 15: A method for wireless communication at a base station, comprising: transmitting, to a UE, a control message indicating a quantity of synchronization rasters for each beam of a plurality of beams; transmitting, for each beam of the plurality of beams, one or more SSBs; monitoring a plurality of random access occasions based at least in part on the quantity of synchronization rasters for each beam of the plurality of beams; and receiving, from the UE, a random access preamble during a random access occasion based at least in part on the monitoring.

Aspect 16: The method of aspect 15, wherein the random access preamble and the random access occasion are associated with a synchronization raster of a beam of the plurality of beams associated with a signal strength that satisfies a threshold signal strength.

Aspect 17: The method of aspect 16, wherein different synchronization rasters correspond to different random access occasions, the method further comprising: transmitting, to the UE, an indication of a parameter associated with a separation in a frequency domain between the different random access occasions, the parameter being used for a calculation, at the UE, of a frequency location associated with the random access occasion, wherein receiving the random access preamble during the random access occasion is based at least in part on the beam, the synchronization raster, and the parameter.

Aspect 18: The method of aspect 16, wherein multiple synchronization rasters of the beam correspond to the random access occasion, the method further comprising: transmitting, to the UE, an indication of a set of random access preambles that are allocated to the multiple synchronization rasters, each synchronization raster of the multiple synchronization rasters being allocated a different subset of random access preambles of the set of random access preambles, wherein receiving the random access preamble is based at least in part on the transmitting of the indication of the set of random access preambles that are allocated to the multiple synchronization rasters.

Aspect 19: The method of aspect 16, wherein multiple synchronization rasters of the beam correspond to the random access occasion, the method further comprising: transmitting, to the UE, a random access response associated with the random access preamble; and receiving, from the UE and based at least in part on transmitting the random access response, a random access message indicating the synchronization raster.

Aspect 20: The method of aspect 19, wherein receiving the random access message indicating the synchronization raster comprises: receiving, via the random access message, a demodulation reference signal associated with a sequence that is based at least in part on the synchronization raster.

Aspect 21: The method of any of aspects 19 or 20, wherein receiving the random access message indicating the synchronization raster comprises: receiving an indication of the synchronization raster via a field of the random access message.

Aspect 22: The method of any of aspects 15 through 21, further comprising: transmitting, to the UE, an indication of a procedure according to which the UE selects one or both of the random access preamble and the random access occasion based at least in part on the quantity of synchronization rasters being associated with each beam of the plurality of beams.

Aspect 23: The method of any of aspects 15 through 22, further comprising: transmitting, to a device controlling a surface, an indication of a configuration of the surface for reflecting communications between the base station and the UE based at least in part on one or both of the random access preamble and the random access occasion.

Aspect 24: The method of any of aspects 15 through 23, wherein the quantity of synchronization rasters is equal to a summation of a quantity of reflected beams from a surface and one synchronization raster associated with direct signaling from the base station without reflection from the surface, and one or both of the random access preamble and the random access occasion are associated with a reflected beam of the quantity of reflected beams.

Aspect 25: The method of any of aspects 15 through 24, wherein each beam and synchronization raster pair corresponds to a different monitoring occasion of a beam sweeping procedure between the base station and the UE and the quantity of monitoring occasions for each beam is equal to the quantity of synchronization rasters for each beam.

Aspect 26: A method for wireless communication at a device controlling a surface, comprising: receiving, from a base station, an indication to divide the surface into a set of portions of the surface, each portion of the set of portions associated with a different reflected beam and a different frequency shift; configuring the set of portions of the surface in accordance with the indication, for reflecting of SSBs from the base station to a UE and for reflecting of a random access preamble from the UE to the base station, the set of portions of the surface in accordance with the indication; and receiving, from the base station, a reconfiguration for the surface for reflecting communications between the base station and the UE based at least in part on the configuring of the set of portions of the surface.

Aspect 27: The method of aspect 26, further comprising: reconfiguring, for the reflecting of the communications between the base station and the UE, the surface in accordance with the reconfiguration.

Aspect 28: The method of any of aspects 26 or 27, wherein the reconfiguration for the surface is based at least in part on a frequency shift of a portion of the surface, the portion of the surface associated with a successful reflection of the random access preamble from the UE to the base station.

Aspect 29: The method of any of aspects 26 through 28, wherein the surface is an RIS comprising a set of reflective elements.

Aspect 30: A method for wireless communication at a base station, comprising: transmitting, to a device controlling a surface, an indication to divide the surface into a set of portions of the surface, each portion of the set of portions associated with a different reflected beam and a different frequency shift; transmitting, to a UE via the surface, one or more SSBs for each beam of a plurality of beams; receiving, from the UE, a random access preamble during a random access occasion based at least in part on the transmitting of the one or more SSBs for each beam of the plurality of beams; and transmitting, to the device controlling the surface, an indication of a reconfiguration for the surface for reflecting communications between the base station and the UE based at least in part on the receiving of the random access preamble during the random access occasion.

Aspect 31: The method of aspect 30, further comprising: monitoring a plurality of random access occasions based at least in part on each portion of the surface being associated with a different frequency shift, wherein different random access occasions of the plurality of random access occasions correspond to different frequency shifts of the set of portions of the surface.

Aspect 32: The method of any of aspects 30 or 31, wherein the reconfiguration of the surface corresponds to the random access occasion in accordance with a mapping.

Aspect 33: The method of any of aspects 30 through 32, wherein the surface is an RIS comprising a set of reflective elements.

Aspect 34: An apparatus for wireless communication at a UE, comprising a processor; memory coupled with the processor; and instructions stored in the memory and executable by the processor to cause the apparatus to perform a method of any of aspects 1 through 14.

Aspect 35: An apparatus for wireless communication at a UE, comprising at least one means for performing a method of any of aspects 1 through 14.

Aspect 36: A non-transitory computer-readable medium storing code for wireless communication at a UE, the code comprising instructions executable by a processor to perform a method of any of aspects 1 through 14.

Aspect 37: An apparatus for wireless communication at a base station, comprising a processor; memory coupled with the processor; and instructions stored in the memory and executable by the processor to cause the apparatus to perform a method of any of aspects 15 through 25.

Aspect 38: An apparatus for wireless communication at a base station, comprising at least one means for performing a method of any of aspects 15 through 25.

Aspect 39: A non-transitory computer-readable medium storing code for wireless communication at a base station, the code comprising instructions executable by a processor to perform a method of any of aspects 15 through 25.

Aspect 40: An apparatus for wireless communication at a device controlling a surface, comprising a processor; memory coupled with the processor; and instructions stored in the memory and executable by the processor to cause the apparatus to perform a method of any of aspects 26 through 29.

Aspect 41: An apparatus for wireless communication at a device controlling a surface, comprising at least one means for performing a method of any of aspects 26 through 29.

Aspect 42: A non-transitory computer-readable medium storing code for wireless communication at a device controlling a surface, the code comprising instructions executable by a processor to perform a method of any of aspects 26 through 29.

Aspect 43: An apparatus for wireless communication at a base station, comprising a processor; memory coupled with the processor; and instructions stored in the memory and executable by the processor to cause the apparatus to perform a method of any of aspects 30 through 33.

Aspect 44: An apparatus for wireless communication at a base station, comprising at least one means for performing a method of any of aspects 30 through 33.

Aspect 45: A non-transitory computer-readable medium storing code for wireless communication at a base station, the code comprising instructions executable by a processor to perform a method of any of aspects 30 through 33.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
a memory; and
a processor coupled to the memory and configured to:
receive, from a base station, a control message indicating a quantity of synchronization rasters for each beam of a plurality of beams;
measure, for each beam of the plurality of beams, one or more synchronization signal blocks over a quantity of monitoring occasions based at least in part on the quantity of synchronization rasters for each beam; and
transmit, to the base station, a random access preamble during a random access occasion selected based at least in part on the measuring.

2. The apparatus of claim 1, wherein, to measure, for each beam of the plurality of beams, the one or more synchronization signal blocks over the quantity of monitoring occasions, the processor is further configured to:
determine that a synchronization signal block associated with a synchronization raster of a beam of the plurality of beams has a signal strength that satisfies a threshold signal strength, wherein transmitting the random access preamble during the random access occasion is based at least in part on the beam and the synchronization raster.

3. The apparatus of claim 2, wherein different synchronization rasters correspond to different random access occasions, and the processor is further configured to:
calculate a frequency location associated with the random access occasion based at least in part on the beam and the synchronization raster; and
select the random access occasion based at least in part on the frequency location.

4. The apparatus of claim 3, wherein the processor is further configured to:
receive an indication of a parameter associated with a separation in a frequency domain between the different random access occasions, wherein calculating the frequency location associated with the random access occasion is further based at least in part on the parameter.

5. The apparatus of claim 2, wherein multiple synchronization rasters of the beam correspond to the random access occasion, and the processor is further configured to:
receive, from the base station, an indication of a set of random access preambles that are allocated to the multiple synchronization rasters, each synchronization raster of the multiple synchronization rasters being allocated a different subset of random access preambles of the set of random access preambles; and
select the random access preamble from a subset of random access preambles that are allocated to the synchronization raster, wherein transmitting the random access preamble during the random access occasion is based at least in part on the selecting of the random access preamble.

6. The apparatus of claim 2, wherein multiple synchronization rasters of the beam correspond to the random access occasion, and the processor is further configured to:
receive, from the base station, a random access response associated with the random access preamble; and
transmit, to the base station and based at least in part on receiving the random access response, a random access message indicating the synchronization raster.

7. The apparatus of claim 6, wherein the processor is further configured to:
generate a sequence for a demodulation reference signal of the random access message based at least in part on the synchronization raster, wherein transmitting the random access message indicating the synchronization raster comprises:
transmit, via the random access message, the demodulation reference signal using the sequence that is generated based at least in part on the synchronization raster.

8. The apparatus of claim 6, wherein, to transmit the random access message indicating the synchronization raster, the processor is further configured to:
transmit an indication of the synchronization raster via a field of the random access message.

9. The apparatus of claim 2, wherein the processor is further configured to:
map the beam and the synchronization raster to an index;
calculate a frequency location associated with the random access occasion based at least in part on the index; and
select the random access occasion based at least in part on the frequency location.

10. The apparatus of claim 9, wherein different beam and synchronization raster pairs correspond to different indices in accordance with a mapping function.

11. The apparatus of claim 1, wherein the processor is further configured to:
receive, from the base station, an indication of a procedure according to which the UE selects one or both of the random access preamble and the random access occasion based at least in part on the quantity of synchronization rasters being associated with each beam of the plurality of beams.

12. The apparatus of claim 11, wherein the procedure is associated with different synchronization rasters corresponding to different random access occasions, or multiple synchronization rasters of a same beam corresponding to a same random access occasion, or use of an index mapped to a beam and a synchronization raster to calculate a frequency location associated with the random access occasion, or a configuration of a surface for reflecting synchronization signal blocks from the base station to the UE and for reflecting the random access preamble from the UE to the base station.

13. The apparatus of claim 1, wherein the quantity of synchronization rasters is equal to a summation of a quantity of reflected beams from a surface and one synchronization raster associated with direct signaling from the base station without reflection from the surface, and one or both of the random access preamble and the random access occasion are associated with a reflected beam of the quantity of reflected beams.

14. The apparatus of claim 1, wherein each beam and synchronization raster pair corresponds to a different monitoring occasion of a beam sweeping procedure between the base station and the UE and the quantity of monitoring occasions for each beam is equal to the quantity of synchronization rasters for each beam.

15. An apparatus for wireless communication at a base station, comprising:
a memory; and
a processor coupled to the memory and configured to:
transmit, to a user equipment (UE), a control message indicating a quantity of synchronization rasters for each beam of a plurality of beams;
transmit, for each beam of the plurality of beams, one or more synchronization signal blocks;
monitor a plurality of random access occasions based at least in part on the quantity of synchronization rasters for each beam of the plurality of beams; and
receive, from the UE, a random access preamble during a random access occasion based at least in part on the monitoring.

16. The apparatus of claim 15, wherein the random access preamble and the random access occasion are associated with a synchronization raster of a beam of the plurality of beams associated with a signal strength that satisfies a threshold signal strength.

17. The apparatus of claim 16, wherein different synchronization rasters correspond to different random access occasions, and the processor is further configured to:
transmit, to the UE, an indication of a parameter associated with a separation in a frequency domain between the different random access occasions, the parameter being used for a calculation, at the UE, of a frequency location associated with the random access occasion, wherein receiving the random access preamble during the random access occasion is based at least in part on the beam, the synchronization raster, and the parameter.

18. The apparatus of claim 16, wherein multiple synchronization rasters of the beam correspond to the random access occasion, and the processor is further configured to:
transmit, to the UE, an indication of a set of random access preambles that are allocated to the multiple synchronization rasters, each synchronization raster of the multiple synchronization rasters being allocated a different subset of random access preambles of the set of random access preambles, wherein receiving the random access preamble is based at least in part on the transmitting of the indication of the set of random access preambles that are allocated to the multiple synchronization rasters.

19. The apparatus of claim 16, wherein multiple synchronization rasters of the beam correspond to the random access occasion, and the processor is further configured to:
transmit, to the UE, a random access response associated with the random access preamble; and
receive, from the UE and based at least in part on transmitting the random access response, a random access message indicating the synchronization raster.

20. The apparatus of claim 19, wherein, to receive the random access message indicating the synchronization raster, the processor is further configured to:
receive, via the random access message, a demodulation reference signal associated with a sequence that is based at least in part on the synchronization raster.

21. The apparatus of claim 19, wherein, to receive the random access message indicating the synchronization raster, the processor is further configured to:
receive an indication of the synchronization raster via a field of the random access message.

22. The apparatus of claim 15, wherein the processor is further configured to:
transmit, to the UE, an indication of a procedure according to which the UE selects one or both of the random access preamble and the random access occasion based at least in part on the quantity of synchronization rasters being associated with each beam of the plurality of beams.

23. The apparatus of claim 15, wherein the processor is further configured to:
transmit, to a device controlling a surface, an indication of a configuration of the surface for reflecting communications between the base station and the UE based at least in part on one or both of the random access preamble and the random access occasion.

24. The apparatus of claim 15, wherein the quantity of synchronization rasters is equal to a summation of a quantity of reflected beams from a surface and one synchronization raster associated with direct signaling from the base station without reflection from the surface, and one or both of the random access preamble and the random access occasion are associated with a reflected beam of the quantity of reflected beams.

25. An apparatus for wireless communication at a device controlling a surface, comprising:
a memory; and
a processor coupled to the memory and configured to:
receive, from a base station, an indication to divide the surface into a set of portions of the surface, each portion of the set of portions associated with a different reflected beam and a different frequency shift;
configure the set of portions of the surface in accordance with the indication, for reflecting of synchronization signal blocks from the base station to a user equipment (UE) and for reflecting of a random access preamble from the UE to the base station; and
receive, from the base station, a reconfiguration for the surface for reflecting communications between the base station and the UE based at least in part on the configuring of the set of portions of the surface.

26. The apparatus of claim 25, wherein the processor is further configured to:
reconfigure, for the reflecting of the communications between the base station and the UE, the surface in accordance with the reconfiguration.

27. The apparatus of claim 25, wherein the reconfiguration for the surface is based at least in part on a frequency shift of a portion of the surface, the portion of the surface associated with a successful reflection of the random access preamble from the UE to the base station.

28. An apparatus for wireless communication at a base station, comprising:
a memory; and
a processor coupled to the memory and configured to:
transmit, to a device controlling a surface, an indication to divide the surface into a set of portions of the surface, each portion of the set of portions associated with a different reflected beam and a different frequency shift;
transmit, to a user equipment (UE) via the surface, one or more synchronization signal blocks for each beam of a plurality of beams;
receive, from the UE, a random access preamble during a random access occasion based at least in part on the transmitting of the one or more synchronization signal blocks for each beam of the plurality of beams; and
transmit, to the device controlling the surface, an indication of a reconfiguration for the surface for reflecting communications between the base station and the UE based at least in part on the receiving of the random access preamble during the random access occasion.

29. The apparatus of claim 28, wherein the processor is further configured to:
monitor a plurality of random access occasions based at least in part on each portion of the surface being associated with the different frequency shift, wherein different random access occasions of the plurality of random access occasions correspond to different frequency shifts of the set of portions of the surface.

30. The apparatus of claim 28, wherein the reconfiguration of the surface corresponds to the random access occasion in accordance with a mapping.
